(19) United States
(12) Patent Application Publication
(10) Pub. No.: US 2026/0271029 A1
(43) Pub. Date: Sep. 10, 2026

(54) TRANSMISSION WITH CONSTRAINT ON SKIPPED PSFCH OCCASIONS

(71) Applicant: Telefonaktiebolaget LM Ericsson (publ), Stockholm (SE)

(72) Inventors: Zhang ZHANG, Beijing (CN); Min WANG, Luleå (SE)

(21) Appl. No.: 19/167,577

(22) PCT Filed: Jan. 29, 2024
(86) PCT No.: PCT/CN2024/074418

§ 371 Date: Sep. 22, 2025

(30) Foreign Application Priority Data
Mar. 30, 2023 (WO) PCT/CN2023/085190

(51) Int. Cl. H04W 72/25; H04L 1/1867

(52) U.S. Cl. CPC H04W 72/25; H04L 1/1896

(57) ABSTRACT

The present disclosure is related to a first terminal device, a second terminal device, and a network node, and methods for transmission with constraint on skipped PSFCH occasions. The method implemented at a first terminal device includes: determining whether or not to skip a Physical Sidelink Feedback Channel (PSFCH) occasion, based on at least one condition or an instruction from a network node. The method further includes at least one of: in response to determining to skip the PSFCH occasion, transmitting or receiving data in the PSFCH occasion, to or from a second terminal device or the network node; and/or in response to determining not to skip the PSFCH occasion, transmitting or receiving Hybrid Automatic Repeat Request (HARQ) feedback in the PSFCH occasion, to or from the second terminal device.

### CROSS-REFERENCE TO RELATED APPLICATION(S)

This application claims priority to the PCT International Application No. PCT/CN2023/085190, entitled “TRANSMISSION WITH CONSTRAINT ON SKIPPED PSFCH OCCASIONS”, filed on Mar. 30, 2023, which is incorporated herein by reference in its entirety.

### TECHNICAL FIELD

The present disclosure is related to the field of telecommunication, and in particular, to a first terminal device, a second terminal device, a network node, and methods for transmission with constraint on skipped Physical Sidelink Feedback Channel (PSFCH) occasions.

### BACKGROUND

With the development of the electronic and telecommunication technologies, mobile devices, such as mobile phones, smart phones, laptops, tablets, vehicle mounted devices, become an important part of our daily lives. To support a numerous number of mobile devices, a highly efficient Radio Access Network (RAN), such as a fifth generation (5G) New Radio (NR) RAN, will be required.

### New Radio Unlicensed Spectrum (NR-U) Introduction

In order to tackle with the ever increasing data demanding, NR is supported on both licensed and unlicensed spectrums (i.e., referred to as NR-U). Compared to the Long Term Evolution (LTE) License Assisted Access (LAA), NR-U supports Dual Connectivity (DC) and standalone scenarios, where the Medium Access Control (MAC) procedures including Random Access Procedure (RACH) and scheduling procedure on unlicensed spectrum are subject to the Listen Before Talk (LBT) failures, while there was no such restriction in LTE LAA, since there was licensed spectrum in LAA scenario so the RACH and scheduling related signaling can be transmitted on the licensed spectrum instead of unlicensed spectrum.

Access to a channel in the unlicensed spectrum, especially in the 5 GHz and 6 GHz band, is guaranteed by Listen Before Talk (LBT) requirements defined by regulations, unlike licensed spectrum which is assigned to a specific operator.

The LBT mechanism mandates a device to sense for the presence of other users' transmissions in the channel before attempting to transmit. The device performs clear channel assessment (CCA) checks on the channel using energy detection (ED) before transmitting. If the channel is found to be idle, i.e. energy detected is below a certain threshold, the device is allowed to transmit. Otherwise, if the channel is found to be occupied (i.e., LBT is failed), the device must defer from transmitting. This mechanism reduces interferences and collisions to other systems and increases probabilities of successful transmissions. After sensing the medium to be idle, the node is typically allowed to transmit for a certain amount of time, sometimes referred to as transmission opportunity (TXOP). The length of the TXOP depends on regulation and type of CCA that has been performed, but typically ranges from 1 ms to 10 ms. This duration is often referred to as a COT (Channel Occupancy Time).

NR-U supports two different LBT modes, dynamic and semi-static channel occupancy for two types of equipment; Load Based Equipment (LBE) and Frame Based Equipment (FBE), respectively.

### Dynamic Channel Occupancy by LBE

3rd Generation Partnership Project (3GPP) Release (Rel) 16 Work Item (WI) NR-U specifies a dynamic channel access mechanism for an LBE type device.

This procedure is designed to randomize the start of transmissions from different nodes that want to access the channel at the same time.

This procedure is commonly known as category 4 (CAT4) LBT, and the procedure for category 4 LBT, also named as Type 1 channel access in TS 37.213 V 17.0.0, which is incorporated herein by reference in its entirety.

### Semi-Static Channel Occupancy by FBE

The Semi-static channel occupancy allows a Frame Based Equipment (FBE) to perform a clear channel assessment per fixed frame period for a duration of single 9 us observation slot. If the channel is found to be busy after CCA operation, the equipment shall not transmit during this fixed frame period. The fixed frame period can be set to a value between 1 and 10 ms and can be adjusted once every 200 ms. If the channel is found to be idle, the equipment can transmit immediately up to a duration referred to as channel occupancy time, after which the equipment shall remain silent for at least 5% of said channel occupancy time. At the end of the required idle period, the equipment can resume CCA for channel access. An example of the FBE based channel occupancy operation is shown in FIG. 1.

The Semi-static channel occupancy generally has difficulty competing with devices that use dynamic channel occupancy (such as LAA or NR-U) for channel access. Dynamic channel occupancy device has the flexibility to access the channel at any time after a successful LBT procedure, while the semi-static channel occupancy devices has one chance for grabbing the channel every fixed frame period. The problems become more exacerbated with longer fixed frame period and higher traffic load. Secondly, the frame based LBT can be rather inflexible for coordinating channel access between networks. If all the nodes are synchronized, then all nodes will find the channel available and transmit simultaneously and cause interference. If the nodes are not synchronized, then some nodes may have definitive advantages in getting access to the channel over some other nodes. Nonetheless, semi-static channel occupancy can be good choice for controlled environments, where a network owner can guarantee absence of dynamic channel occupancy devices and is in control of the behavior of all devices competing to access the channel. In fact, in such deployment, semi-static channel occupancy is an attractive solution because access latencies can be reduced to the minimum and lower complexity is required for channel access due to lack of necessity to perform random backoff.

It has been identified that FBE operation for the scenario where it is guaranteed that LBE nodes are absent on a long-term basis (e.g., by level of regulation) and FBE gNBs are synchronized can achieve the following:
Ability to use frequency reuse factor 1;
Lower complexity for channel access due to lack of necessity to perform random backoff.

### Wideband Operation in NR-U

As in NR licensed, it is expected that NR-U will support transmission over a wide bandwidth (>>20 MHz). It is expected that this can be achieved in two different ways: (1) carrier aggregation with configuration of multiple serving cells, e.g., each with 20 MHz bandwidth, and (2) configuration of a single wideband serving cell with bandwidth as an integer multiple of 20 MHz, e.g., 80 MHz.

The following objective has been studied for NR-U in 3GPP Rel-16 :

Wide band operation (in integer multiples of 20 MHz) for DL and UL for NR-U supported with multiple serving cells, and wideband operation (in integer multiples of 20 MHz) for downlink (DL) and uplink (UL) for NR-U supported with one serving cell with bandwidth >20 MHz with potential scheduling constraint subject to input from RAN 2 and RAN4 on feasibility of operating the wideband carrier when LBT is unsuccessful in one or more LBT subbands within the wideband carrier. For all wide-band operation cases, CCA is performed in units of 20 MHz (at least for 5 GHz).

A wideband operation refers to operation within a channel bandwidth larger than 20 MHz in a shared spectrum. The device can access the shared spectrum for operation based on the outcome of the CCA procedure. The wideband operation comprises of two or more sub-bands. A sub-band is the set of Radio Blocks (RBs) within an approximately 20 MHz segment of the channel where the wideband channel is uniformly divided into an integer number of 20 MHz sub-bands. The sub-bands may be separately allocated in uplink and downlink.

In both scenarios, CCA is performed in units of 20 MHz (e.g. in 5 GHz, 6 GHz etc). We may define two modes according to relationship between the carrier bandwidth (CBW) and the LBT bandwidth (LBW).

In the first mode, multiple carriers are aggregated, and for each carrier the relationship is that CBW=LBT. For the second mode, a single wideband carrier is used and the relationship is CBW>LBW. In the second mode, the wideband carrier therefore consists of multiple “LBT sub-bands” or multiple “LBT bandwidths.” This terminology may be applied generically for both the 5 and 6 GHz bands. For example in 5 GHz or 6 GHz band, in one example LBW =20 MHz. In 5 GHz in some regions the LBW may be smaller e.g. 10 MHz.

An example of a wideband carrier containing multiple LBT subbands is illustrated in FIG. 2.

### Sidelink

3GPP specified the LTE D2D (device-to-device) technology, also known as sidelink (SL) or the PC5 interface, as part of Release 12 (Rel-12). The target use case was the Proximity Services (communication and discovery). Support was enhanced during Rel-13. In Rel-14, the LTE sidelink was extensively redesigned to support vehicular communications (commonly referred to as Vehicle-to-everything (V2X) or Vehicle-to-vehicle (V2V)). Support was again enhanced during Rel-15. From the point of view of the lowest radio layers, the LTE SL uses broadcast communication. That is, transmission from a UE targets any receiver that is in range.

In Rel-16, 3GPP introduced sidelink for the 5G new radio (NR). The driving use case was vehicular communications with more stringent requirements than those typically served using the LTE SL. To meet these requirements, the NR SL is capable of broadcast, groupcast, and unicast communications. In groupcast communication, the intended receivers of a message are typically a subset of the vehicles near the transmitter, whereas in unicast communication, there is a single intended receiver. Hybrid Automatic Repeat Request (HARQ) feedback based retransmission is supported for unicast and groupcast.

NR SL introduces 2 stage sidelink control information (SCI), the 1st stage SCI is transmitted on Physical Sidelink Control Channel (PSCCH) and used for the scheduling of Physical Sidelink Shared Channel (PSSCH) and 2nd stage SCI on PSSCH. PSCCH carrying 1st stage SCI and the PSSCH scheduled by the 1st stage SCI are transmitted in the same slot but in different symbols.

SL HARQ feedback is transmitted in Physical Sidelink Feedback Channel (PSFCH). For each resource pool it is (pre)configured a period of PSFCH resource in the unit of slots (denoted periodPSFCH). A zero period means no PSFCH resource in the resource pool. FIG. 3 shows the slot formats without and with PSFCH occasion. No SL transmission or reception is performed during guard period (GP).

NR sidelink transmissions have the following two modes of resource allocations:
Mode 1: Sidelink resources are scheduled by the gNB, including both dynamic scheduling and configured grant.
Mode 2: The UE autonomously selects sidelink resources from a (pre-)configured sidelink resource pool(s) based on the channel sensing mechanism.

For RRC CONNECTED UE, a UE can be configured to adopt either Mode 1 or Mode 2 resource allocation (RA). In other cases, only Mode 2 can be adopted.

### Multi-Consecutive Slots Transmission (MCSt)

Multi-consecutive slots transmission (also often referred as burst, back-to-back or just multi-slot transmission) is studied in 3 GPP Rel-18 for sidelink operation in the unlicensed spectrum due to the following two main motivations:
COT retaining to avoid long gap (at slot level) between SL transmissions
Improve channel access efficiency by reducing number of channel accesses for transmitting a TB or multiple TBs.

In order to enable/introduce “multi-consecutive slots TX” in sidelink, the work will involve multiple aspects including channel access (at slot boundary), resource allocation (sensing, selection and reservation), and physical (PHY) channel design (PSCCH/PSSCH mapping, rate matching).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The present disclosure proposes an improved solution of determining whether to skip a PSFCH occasion.

According to a first aspect of the present disclosure, a method implemented at a first terminal device is provided. The method comprises: determining whether or not to skip a Physical Sidelink Feedback Channel (PSFCH) occasion, based on at least one condition or an instruction from a network node. The method further comprises at least one of: in response to determining to skip the PSFCH occasion, transmitting or receiving data in the PSFCH occasion, to or from a second terminal device or the network node; and/or in response to determining not to skip the PSFCH occasion, transmitting or receiving Hybrid Automatic Repeat Request (HARQ) feedback in the PSFCH occasion, to or from the second terminal device.

In some embodiments, the PSFCH occasion is during a Multi-Consecutive Slots transmission (MCSt) period.

In some embodiments, the at least one condition is associated to one or multiple of: a Quality of Service (QOS) requirement for data of a service/traffic type/Logic Channel (LCH) in the MCSt period; a period for the first terminal device occupying a channel; remaining battery of the first terminal device; a priority of data/LCH associated to a HARQ feedback that the first terminal device expects to receive in the PSFCH occasion; a latency requirement of data/LCH associated to a HARQ feedback that the first terminal device expects to receive in the PSFCH occasion; a priority of data/LCH associated to a HARQ feedback that the first terminal device needs to transmit in the PSFCH occasion; a latency requirement of data/LCH associated to a HARQ feedback that the first terminal device needs to transmit in the PSFCH occasion; a maximum number of consecutive PSFCH occasions that are allowed to be skipped (maxPSFCHoccasionskip).

In some embodiments, the at least one condition for determining to skip the PSFCH occasion comprises one or multiple of: a priority of data of a service/traffic type/LCH in the MCSt period is greater than or equal to a priority threshold; a latency requirement of data of a service/traffic type/LCH in the MCSt period is less than or equal to a latency threshold; a queuing delay of data of a service/traffic type/LCH in the MCSt period is greater than or equal to a queuing delay threshold; a remaining packet delay budget of data of a service/traffic type/LCH in the MCSt period is less than or equal to a remaining packet delay budget threshold; a data volume of data of a service/traffic type/LCH in the MCSt period, which is pending for transmission, is greater than or equal to a data volume threshold; a period since the first terminal device has occupied the channel last time is less than or equal to a period threshold; remaining battery of the first terminal device is less than or equal to a battery threshold; the HARQ feedback that the first terminal device is expecting to receive in the PSFCH occasion is associated to data/LCH with priority less than or equal to a receiving HARQ feedback priority threshold; the HARQ feedback that the first terminal device is expecting to receive in the PSFCH occasion is associated to data/LCH with latency requirement greater than or equal to a receiving HARQ feedback latency threshold; the HARQ feedback that the first terminal device needs to transmit in the PSFCH occasion is associated to data/LCH with priority less than or equal to a transmitting HARQ feedback priority threshold; the HARQ feedback that the first terminal device needs to transmit in the PSFCH occasion is associated to data/LCH with latency requirement greater than or equal to a transmitting HARQ feedback latency threshold; a number of consecutive PSFCH occasions that has skipped is less than a maximum number of consecutive PSFCH occasions that are allowed to be skipped (maxPSFCHoccasionₛₖᵢₚ).

In some embodiments, the at least one condition for determining not to skip the PSFCH occasion comprises one or multiple of: a priority of data of a service/traffic type/LCH in the MCSt period is less than or equal to a priority threshold; a latency requirement of data of a service/traffic type/LCH in the MCSt period is greater than or equal to a latency threshold; a queuing delay of data of a service/traffic type/LCH in the MCSt period is less than or equal to a queuing delay threshold; a remaining packet delay budget of data of a service/traffic type/LCH in the MCSt period is greater than or equal to a remaining packet delay budget threshold; a data volume of data of a service/traffic type/LCH in the MCSt period, which is pending for transmission, is less than or equal to a data volume threshold; a period since the first terminal device has occupied the channel last time is greater than or equal to a period threshold; remaining battery of the first terminal device is greater than or equal to a battery threshold; the HARQ feedback that the first terminal device is expecting to receive in the PSFCH occasion is associated to data/LCH with priority greater than or equal to a receiving HARQ feedback priority threshold; the HARQ feedback that the first terminal device is expecting to receive in the PSFCH occasion is associated to data/LCH with latency requirement less than or equal to a receiving HARQ feedback latency threshold; the HARQ feedback that the first terminal device needs to transmit in the PSFCH occasion is associated to data/LCH with priority greater than or equal to a transmitting HARQ feedback priority threshold; the HARQ feedback that the first terminal device needs to transmit in the PSFCH occasion is associated to data/LCH with latency requirement less than or equal to a transmitting HARQ feedback latency threshold; a number of consecutive PSFCH occasions that has skipped is greater than or equal to a maximum number of consecutive PSFCH occasions that are allowed to be skipped (maxPSFCHoccasionₛₖᵢₚ).

In some embodiments, the method further comprises: receiving a Downlink Control Indicator (DCI), Medium Access Control-Control Element (MAC-CE) or Radio Resource Control (RRC) signaling carrying the instruction from the network node.

In some embodiments, transmitting or receiving data in the PSFCH occasion comprises performing Physical Sidelink Shared Channel (PSSCH) or Physical Sidelink Control Channel (PSCCH) transmission or reception in full or part of the PSFCH occasion.

In some embodiments, the method further comprises: transmitting first information to a second terminal device via at least one of: PC5-S signaling; Discovery message; PC5-RRC signaling; sidelink MAC-CE; Sidelink Control Information (SCI); Layer 1 (L1) signaling.

In some embodiments, the method further comprises: transmitting second information to the network node via at least one of: Uu-RRC signaling; MAC-CE; Layer 1 (L1) signaling.

In some embodiments, the first information or second information comprises at least one of: a resource pool/Listen Before Talk (LBT) band in which the PSFCH occasion is recommended/allowed to be skipped; a slot in which the first terminal device has determined that the PSFCH occasion will be skipped; the at least one condition for skipping the PSFCH occasion; the determination that the PSFCH occasion is to be skipped or not to be skipped for the first terminal device; a recommendation that the PSFCH occasion is to be skipped or not to be skipped for the second terminal device; the maximum number of consecutive PSFCH occasions that are allowed to be skipped (maxPSFCHoccasionₛₖᵢₚ).

In some embodiments, the maximum number of consecutive PSFCH occasions that are allowed to be skipped (maxPSFCHoccasionₛₖᵢₚ) is configured per at least one of: resource pool, LBT band, transmitting (Tx) terminal device, receiving (Rx) terminal device, QoS profile, Resource Block (RB)/LCH.

In some embodiments, when the first terminal device is a Tx terminal device, and for per resource pool or per LBT band maxPSFCHoccasionₛₖᵢₚ, the method further comprises: taking a number of consecutively skipped PSFCH occasions in a resource pool or a LBT band into account, when performing resource selection/reselection, or when determining how to perform transmission using the obtained resource, so that the number of consecutively skipped PSFCH occasions in that resource pool or LBT band does not exceed the maxPSFCHoccasionₛₖᵢₚ of the resource pool or LBT band.

In some embodiments, when the first terminal device is a Tx terminal device and for per Tx terminal device maxPSFCHoccasionₛₖᵢₚ the method further comprises: taking a number of consecutively skipped PSFCH occasions where the first terminal device needs to monitor HARQ feedback into account, when performing selection/reselection, or when determining how to perform transmission using the obtained resources, so that the number of consecutively skipped PSFCH occasions does not exceed the maxPSFCHoccasionₛₖᵢₚ Of the first terminal device.

In some embodiments, when the first terminal device is a Tx terminal device and for per Rx terminal device maxPSFCHoccasionₛₖᵢₚ, the method further comprises: taking a number of consecutively skipped PSFCH occasions where the Rx terminal device needs to transmit HARQ feedback into account when performing transmissions, so that the number of consecutively skipped PSFCH occasions does not exceed the maxPSFCHoccassionₛₖᵢₚ of the the Rx terminal device.

In some embodiments, when the first terminal device is a Tx terminal device and for per QoS profile or RB/LCH maxPSFCHoccasionₛₖᵢₚ, the method further comprises: taking a number of consecutively skipped PSFCH occasions where the first terminal device needs to monitor HARQ feedback into account, when performing selection/reselection, or when determining how to perform transmission using the obtained resources, so that the number of consecutively skipped PSFCH occasions does not exceed the maxPSFCHoccasionₛₖᵢₚ of the first terminal device.

In some embodiments, the maxPSFCHoccasionₛₖᵢₚ is determined based on QoS profile of the transmitted data or the RB/LCH.

In some embodiments, the maxPSFCHoccasionₛₖᵢₚ is determined as the maxPSFCHoccasionₛₖᵢₚ with the smallest value among the multiple per QoS profile or RB/LCH maxPSFCHoccasionₛₖᵢₚ.

In some embodiments, the method further comprises: updating the maxPSFCHoccasionₛₖᵢₚ when the service is started/stopped or the RB/LCH is configured/reconfigured.

According to a second aspect of the present disclosure, an apparatus implemented in a first terminal device is provided. The apparatus comprises: one or more processors; and one or more memories comprising computer program codes. The one or more memories and the computer program codes configured to, with the one or more processors, cause the apparatus to perform any of the methods of the first aspect.

According to a third aspect of the present disclosure, a method implemented at a second terminal device is provided. The method comprises: receiving or transmitting data in a Physical Sidelink Feedback Channel (PSFCH) occasion, from or to a first terminal device, in response to a determination that the PSFCH occasion is to be skipped, and/or receiving or transmitting Hybrid Automatic Repeat Request (HARQ) feedback in the PSFCH occasion, from or to a first terminal device, in response to a determination that the PSFCH occasion is not to be skipped. The determination is based on at least one condition or an instruction from a network node.

In some embodiments, the PSFCH occasion is during a Multi-Consecutive Slots transmission (MCSt) period.

In some embodiments, the at least one condition is associated to one or multiple of: a Quality of Service (QOS) requirement for data of a service/traffic type/Logic Channel (LCH) in the MCSt period; a period for the first terminal device occupying a channel; remaining battery of the first terminal device; a priority of data/LCH associated to a HARQ feedback that the first terminal device expects to receive in the PSFCH occasion; a latency requirement of data/LCH associated to a HARQ feedback that the first terminal device expects to receive in the PSFCH occasion; a priority of data/LCH associated to a HARQ feedback that the first terminal device needs to transmit in the PSFCH occasion; a latency requirement of data/LCH associated to a HARQ feedback that the first terminal device needs to transmit in the PSFCH occasion; a maximum number of consecutive PSFCH occasions that are allowed to be skipped (maxPSFCHoccasionskip).

In some embodiments, the at least one condition for determining to skip the PSFCH occasion comprises one or multiple of: a priority of data of a service/traffic type/LCH in the MCSt period is greater than or equal to a priority threshold; a latency requirement of data of a service/traffic type/LCH in the MCSt period is less than or equal to a latency threshold; a queuing delay of data of a service/traffic type/LCH in the MCSt period is greater than or equal to a queuing delay threshold; a remaining packet delay budget of data of a service/traffic type/LCH in the MCSt period is less than or equal to a remaining packet delay budget threshold; a data volume of data of a service/traffic type/LCH in the MCSt period, which is pending for transmission, is greater than or equal to a data volume threshold; a period since the first terminal device has occupied the channel last time is less than or equal to a period threshold; remaining battery of the first terminal device is less than or equal to a battery threshold; the HARQ feedback that the first terminal device is expecting to receive in the PSFCH occasion is associated to data/LCH with priority less than or equal to a receiving HARQ feedback priority threshold; the HARQ feedback that the first terminal device is expecting to receive in the PSFCH occasion is associated to data/LCH with latency requirement greater than or equal to a receiving HARQ feedback latency threshold; the HARQ feedback that the first terminal device needs to transmit in the PSFCH occasion is associated to data/LCH with priority less than or equal to a transmitting HARQ feedback priority threshold; the HARQ feedback that the first terminal device needs to transmit in the PSFCH occasion is associated to data/LCH with latency requirement greater than or equal to a transmitting HARQ feedback latency threshold; a number of consecutive PSFCH occasions that has skipped is less than a maximum number of consecutive PSFCH occasions that are allowed to be skipped (maxPSFCHoccasionₛₖᵢₚ).

In some embodiments, the at least one condition for determining not to skip the PSFCH occasion comprises one or multiple of: a priority of data of a service/traffic type/LCH in the MCSt period is less than or equal to a priority threshold; a latency requirement of data of a service/traffic type/LCH in the MCSt period is greater than or equal to a latency threshold; a queuing delay of data of a service/traffic type/LCH in the MCSt period is less than or equal to a queuing delay threshold; a remaining packet delay budget of data of a service/traffic type/LCH in the MCSt period is greater than or equal to a remaining packet delay budget threshold; a data volume of data of a service/traffic type/LCH in the MCSt period, which is pending for transmission, is less than or equal to a data volume threshold; a period since the first terminal device has occupied the channel last time is greater than or equal to a period threshold; remaining battery of the first terminal device is greater than or equal to a battery threshold; the HARQ feedback that the first terminal device is expecting to receive in the PSFCH occasion is associated to data/LCH with priority greater than or equal to a receiving HARQ feedback priority threshold; the HARQ feedback that the first terminal device is expecting to receive in the PSFCH occasion is associated to data/LCH with latency requirement less than or equal to a receiving HARQ feedback latency threshold; the HARQ feedback that the first terminal device needs to transmit in the PSFCH occasion is associated to data/LCH with priority greater than or equal to a transmitting HARQ feedback priority threshold; the HARQ feedback that the first terminal device needs to transmit in the PSFCH occasion is associated to data/LCH with latency requirement less than or equal to a transmitting HARQ feedback latency threshold; a number of consecutive PSFCH occasions that has skipped is greater than or equal to a maximum number of consecutive PSFCH occasions that are allowed to be skipped (maxPSFCHoccasionₛₖᵢₚ).

In some embodiments, the method further comprises: receiving or transmitting data in the PSFCH occasion comprises performing Physical Sidelink Shared Channel (PSSCH) or Physical Sidelink Control Channel (PSCCH) reception or transmission in full or part of the PSFCH occasion.

In some embodiments, the method further comprises: receiving first information from the first terminal device via at least one of: PC5-S signaling; Discovery message; PC5-RRC signaling; sidelink MAC-CE; Sidelink Control Information (SCI); Layer 1 (L1) signaling.

In some embodiments, the first information comprises at least one of: a resource pool/Listen Before Talk (LBT) band in which the PSFCH occasion is recommended/allowed to be skipped; a slot in which the first terminal device has determined that the PSFCH occasion will be skipped; the at least one condition for skipping the PSFCH occasion; the determination that the PSFCH occasion is to be skipped or not to be skipped for the first terminal device; a recommendation that the PSFCH occasion is to be skipped or not to be skipped for the second terminal device; the maximum number of consecutive PSFCH occasions that are allowed to be skipped (maxPSFCHoccasionₛₖᵢₚ).

In some embodiments, the method further comprises: at least one of: skipping monitoring the HARQ feedback expected from the first terminal device in the PSFCH occasion which is determined to be skipped by the first terminal device and/or recommended to be skipped for the second terminal device; skipping transmitting the HARQ feedback to the first terminal device in the PSFCH occasion which is determined to be skipped by the first terminal device and/or recommended to be skipped for the second terminal device; postponing the HARQ feedback reception from the first terminal device or HARQ feedback transmission to the first terminal device, to a later available PSFCH occasion.

In some embodiments, the maximum number of consecutive PSFCH occasions that are allowed to be skipped (maxPSFCHoccasionₛₖᵢₚ) is configured per at least one of: resource pool, LBT band, transmitting (Tx) terminal device, receiving (Rx) terminal device, QoS profile, Resource Block (RB)/LCH.

According to a fourth aspect of the present disclosure, an apparatus implemented in a second terminal device is provided. The apparatus comprises: one or more processors; and one or more memories comprising computer program codes. The one or more memories and the computer program codes configured to, with the one or more processors, cause the apparatus to perform any of the methods of the third aspect.

According to a fifth aspect of the present disclosure, a method implemented at a network node is provided. The method comprises: determining an instruction for a first terminal device about whether or not to skip a Physical Sidelink Feedback Channel (PSFCH) occasion, based on at least one condition; and transmitting the instruction to the first terminal device.

In some embodiments, the method further comprises: receiving or transmitting data in the PSFCH occasion, from or to the first terminal device, in response to a determination that the PSFCH occasion is to be skipped.

In some embodiments, the PSFCH occasion is during a Multi-Consecutive Slots transmission (MCSt) period.

In some embodiments, the at least one condition is associated to one or multiple of: a Quality of Service (QOS) requirement for data of a service/traffic type/Logic Channel (LCH) in the MCSt period; a period for the first terminal device occupying a channel; remaining battery of the first terminal device; a priority of data/LCH associated to a HARQ feedback that the first terminal device expects to receive in the PSFCH occasion; a latency requirement of data/LCH associated to a HARQ feedback that the first terminal device expects to receive in the PSFCH occasion; a priority of data/LCH associated to a HARQ feedback that the first terminal device needs to transmit in the PSFCH occasion; a latency requirement of data/LCH associated to a HARQ feedback that the first terminal device needs to transmit in the PSFCH occasion; a maximum number of consecutive PSFCH occasions that are allowed to be skipped (maxPSFCHoccasionskip).

In some embodiments, the at least one condition for determining to skip the PSFCH occasion comprises one or multiple of: a priority of data of a service/traffic type/LCH in the MCSt period is greater than or equal to a priority threshold; a latency requirement of data of a service/traffic type/LCH in the MCSt period is less than or equal to a latency threshold; a queuing delay of data of a service/traffic type/LCH in the MCSt period is greater than or equal to a queuing delay threshold; a remaining packet delay budget of data of a service/traffic type/LCH in the MCSt period is less than or equal to a remaining packet delay budget threshold; a data volume of data of a service/traffic type/LCH in the MCSt period, which is pending for transmission, is greater than or equal to a data volume threshold; a period since the first terminal device has occupied the channel last time is less than or equal to a period threshold; remaining battery of the first terminal device is less than or equal to a battery threshold; the HARQ feedback that the first terminal device is expecting to receive in the PSFCH occasion is associated to data/LCH with priority less than or equal to a receiving HARQ feedback priority threshold; the HARQ feedback that the first terminal device is expecting to receive in the PSFCH occasion is associated to data/LCH with latency requirement greater than or equal to a receiving HARQ feedback latency threshold; the HARQ feedback that the first terminal device needs to transmit in the PSFCH occasion is associated to data/LCH with priority less than or equal to a transmitting HARQ feedback priority threshold; the HARQ feedback that the first terminal device needs to transmit in the PSFCH occasion is associated to data/LCH with latency requirement greater than or equal to a transmitting HARQ feedback latency threshold; a number of consecutive PSFCH occasions that has skipped is less than a maximum number of consecutive PSFCH occasions that are allowed to be skipped (maxPSFCHoccasionₛₖᵢₚ).

In some embodiments, the at least one condition for determining not to skip the PSFCH occasion comprises one or multiple of: a priority of data of a service/traffic type/LCH in the MCSt period is less than or equal to a priority threshold; a latency requirement of data of a service/traffic type/LCH in the MCSt period is greater than or equal to a latency threshold; a queuing delay of data of a service/traffic type/LCH in the MCSt period is less than or equal to a queuing delay threshold; a remaining packet delay budget of data of a service/traffic type/LCH in the MCSt period is greater than or equal to a remaining packet delay budget threshold; a data volume of data of a service/traffic type/LCH in the MCSt period, which is pending for transmission, is less than or equal to a data volume threshold; a period since the first terminal device has occupied the channel last time is greater than or equal to a period threshold; remaining battery of the first terminal device is greater than or equal to a battery threshold; the HARQ feedback that the first terminal device is expecting to receive in the PSFCH occasion is associated to data/LCH with priority greater than or equal to a receiving HARQ feedback priority threshold; the HARQ feedback that the first terminal device is expecting to receive in the PSFCH occasion is associated to data/LCH with latency requirement less than or equal to a receiving HARQ feedback latency threshold; the HARQ feedback that the first terminal device needs to transmit in the PSFCH occasion is associated to data/LCH with priority greater than or equal to a transmitting HARQ feedback priority threshold; the HARQ feedback that the first terminal device needs to transmit in the PSFCH occasion is associated to data/LCH with latency requirement less than or equal to a transmitting HARQ feedback latency threshold; a number of consecutive PSFCH occasions that has skipped is greater than or equal to a maximum number of consecutive PSFCH occasions that are allowed to be skipped (maxPSFCHoccasionₛₖᵢₚ).

In some embodiments, the instruction is carried in a Downlink Control Indicator (DCI), Medium Access Control-Control Element (MAC-CE) or Radio Resource Control (RRC) signaling.

In some embodiments, the method further comprises: receiving or transmitting data in the PSFCH occasion comprises performing reception or transmission in full or part of the PSFCH occasion.

In some embodiments, the method further comprises: receiving second information from the first terminal device via at least one of: Uu-RRC signaling; MAC-CE; Layer 1 (L1) signaling.

In some embodiments, the second information comprises at least one of: a resource pool/Listen Before Talk (LBT) band in which the PSFCH occasion is recommended/allowed to be skipped; a slot in which the first terminal device has determined that the PSFCH occasion will be skipped; the at least one condition for skipping the PSFCH occasion; the determination that the PSFCH occasion is to be skipped or not to be skipped for the first terminal device; a recommendation that the PSFCH occasion is to be skipped or not to be skipped for the second terminal device; the maximum number of consecutive PSFCH occasions that are allowed to be skipped (maxPSFCHoccasionₛₖᵢₚ).

In some embodiments, the method further comprises at least one of: forwarding the second information to a second terminal device; reconfiguring the PSFCH occasion in the resource pool or LBT band.

In some embodiments, the determination is further based on sidelink (SL) Buffer Status Report (BSR) received from the first terminal device.

In some embodiments, the maximum number of consecutive PSFCH occasions that are allowed to be skipped (maxPSFCHoccasionₛₖᵢₚ) is configured per at least one of: resource pool, LBT band, transmitting (Tx) terminal device, receiving (Rx) terminal device, QoS profile, Resource Block (RB)/LCH.

In some embodiments, for per resource pool or per LBT band maxPSFCHoccasionₛₖᵢₚ, the method further comprises: taking a number of consecutively skipped PSFCH occasions in a resource pool or a LBT band into account, when performing sidelink resource allocation, so that the number of consecutively skipped PSFCH occasions in that resource pool or LBT band does not exceed the maxPSFCHoccasionₛₖᵢₚ of the resource pool or LBT band.

In some embodiments, for per Tx terminal device maxPSFCHoccasionₛₖᵢₚ the method further comprises: taking a number of consecutively skipped PSFCH occasions where the first terminal device needs to monitor HARQ feedback into account, when performing sidelink resource allocation, so that the number of consecutively skipped PSFCH occasions does not exceed the maxPSFCHoccasionₛₖᵢₚ of the first terminal device.

In some embodiments, for per Rx terminal device maxPSFCHoccasionₛₖᵢₚ, the method further comprises: taking a number of consecutively skipped PSFCH occasions where the Rx terminal device needs to transmit HARQ feedback into account when performing transmissions, so that the number of consecutively skipped PSFCH occasions does not exceed the maxPSFCHoccasionₛₖᵢₚ of the Rx terminal device.

In some embodiments, when the first terminal device is a Tx terminal device and for per QoS profile or RB/LCH maxPSFCHoccasionₛₖᵢₚ, the method further comprises: taking a number of consecutively skipped PSFCH occasions where the first terminal device needs to monitor HARQ feedback into account, when sidelink resource allocation, so that the number of consecutively skipped PSFCH occasions does not exceed the maxPSFCHoccasionₛₖᵢₚ of the first terminal device.

In some embodiments, the maxPSFCHoccasionₛₖᵢₚ is determined based on QoS profile of the transmitted data or the RB/LCH.

In some embodiments, the maxPSFCHoccasionₛₖᵢₚ is determined as the maxPSFCHoccasionₛₖᵢₚ with the smallest value among the multiple per QoS profile or RB/LCH maxPSFCHoccasionₛₖᵢₚ.

In some embodiments, the method further comprises: updating the maxPSFCHoccasionₛₖᵢₚ when the service is started/stopped or the RB/LCH is configured/reconfigured.

According to a sixth aspect of the present disclosure, an apparatus implemented in a network node is provided. The apparatus comprises: one or more processors; and one or more memories comprising computer program codes. The one or more memories and the computer program codes configured to, with the one or more processors, cause the apparatus to perform any of the methods of the fifth aspect.

According to a seventh aspect of the present disclosure, a computer-readable medium having computer program codes embodied thereon for use with a computer. The computer program codes comprise codes for performing the method according to any one of the first, third, or fifth aspect.

According to an eighth aspect of the present disclosure, an apparatus implemented in a first terminal device is provided. The apparatus comprises: a determining module configured to determine whether or not to skip a Physical Sidelink Feedback Channel (PSFCH) occasion, based on at least one condition or an instruction from a network node; and a transmitting or receiving module configured to, in response to determining to skip the PSFCH occasion, transmit or receive data in the PSFCH occasion, to or from a second terminal device or the network node, and/or in response to determining not to skip the PSFCH occasion, transmit or receive Hybrid Automatic Repeat Request (HARQ) feedback in the PSFCH occasion, to or from the second terminal device. In some embodiments, the apparatus comprises one or more further modules, each of which may perform any of the methods of the first aspect.

According to a ninth aspect of the present disclosure, an apparatus implemented in a second terminal device is provided. The apparatus comprises: a receiving or transmitting module configured to receive or transmit data in a Physical Sidelink Feedback Channel (PSFCH) occasion, from or to a first terminal device, in response to a determination that the PSFCH occasion is to be skipped; and/or receive or transmit Hybrid Automatic Repeat Request (HARQ) feedback in the PSFCH occasion, from or to a first terminal device, in response to a determination that the PSFCH occasion is not to be skipped. The determination is based on at least one condition or an instruction from a network node. In some embodiments, the apparatus comprises one or more further modules, each of which may perform any of the methods of the third aspect.

According to a tenth aspect of the present disclosure, an apparatus implemented in a network node is provided. The apparatus comprises: a determining module configured to determine an instruction for a first terminal device about whether or not to skip a Physical Sidelink Feedback Channel (PSFCH) occasion, based on at least one condition; and a transmitting module configured to transmit the instruction to the first terminal device. In some embodiments, the apparatus comprises one or more further modules, each of which may perform any of the methods of the fifth aspect.

With some embodiments of the present disclosure, it can be determined properly whether or not a PSFCH occasion should be skipped, therefore unnecessary HARQ feedback transmission/reception is avoided in the skipped PSFCH occasion, and it is also avoided to skip too many consecutive PSFCH occasions which may lead to insufficient PSFCH resources and/or long HARQ feedback latency.

### BRIEF DESCRIPTION OF THE DRAWINGS

FIG. 1 is a diagram illustrating semi-static channel occupancy operation.

FIG. 2 is a diagram illustrating a wideband carrier containing a BWP with four 20 MHz subbands.

FIG. 3 is a diagram illustrating sidelink slot formats without and with PSFCH occasion.

FIG. 4 is a diagram illustrating avoidance of large number of consecutively skipped PSFCH occasions.

FIG. 5 is a flow chart illustrating an exemplary method at a first terminal device according to an embodiment of the present disclosure.

FIG. 6 is a flow chart illustrating an exemplary method at a second terminal device according to an embodiment of the present disclosure.

FIG. 7 is a flow chart illustrating an exemplary method at a network node according to an embodiment of the present disclosure.

FIG. 8 schematically shows an embodiment of an arrangement which may be used in a first terminal device, a second terminal device or a network node according to an embodiment of the present disclosure.

FIG. 9A is a block diagram of an exemplary first terminal device according to an embodiment of the present disclosure.

FIG. 9B is a block diagram of an exemplary second terminal device according to an embodiment of the present disclosure.

FIG. 9C is a block diagram of an exemplary network node according to an embodiment of the present disclosure.

FIG. 10 shows an example of a communication system in accordance with some embodiments of the present disclosure.

FIG. 11 shows an exemplary UE in accordance with some embodiments of the present disclosure.

FIG. 12 shows an exemplary network node in accordance with some embodiments of the present disclosure.

FIG. 13 is a block diagram of an exemplary host, which may be an embodiment of the host of FIG. 10, in accordance with various aspects described herein.

FIG. 14 is a block diagram illustrating an exemplary virtualization environment in which functions implemented by some embodiments may be virtualized.

FIG. 15 shows a communication diagram of an exemplary host communicating via an exemplary network node with an exemplary UE over a partially wireless connection in accordance with some embodiments of the present disclosure.

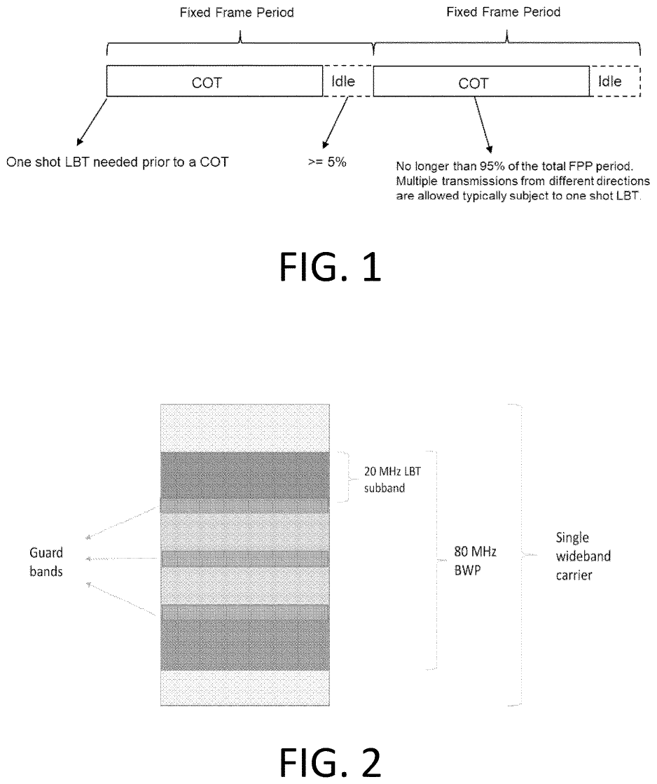

### DETAILED DESCRIPTION

Hereinafter, the present disclosure is described with reference to embodiments shown in the attached drawings. However, it is to be understood that those descriptions are just provided for illustrative purpose, rather than limiting the present disclosure.

Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as transmission with constraint on skipped PSFCH occasions is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, etc. Therefore, one skilled in the arts could readily understand that the terms used herein may also refer to their equivalents in any other infrastructure. For example, the term “terminal device” used herein may refer to a UE, a mobile device, a mobile terminal, a mobile station, a user device, a user terminal, a wireless device, a wireless terminal, or any other equivalents. For another example, the term “network node” used herein may refer to a transmission reception point (TRP), a base station, a base transceiver station, an access point, a hot spot, a NodeB, an Evolved NodeB (eNB), a gNB, a network element, or any other equivalents.

For a resource pool (pre)configured with PSFCH resources, a UE expects that a slot tₖ belonging to that resource pool contains a PSFCH transmission occasion if k mod period_{PSFCH}=0.

Each PSFCH occasion is (pre)configured with M_{PSFCH} PRBs for PSFCH transmission. For a resource pool having N_{subchannel-pool} subchannels, each subchannel in a slot is associated with M_{PSFCH-subchannel}=M_{PSFCH}/(N_{subchannel-pool}*period_{PSFCH}) PRBs for PSFCH transmission. The UE expects that M_{PSFCH} is a multiple of N_{subchannel-pool}*period_{PSFCH}.

If a UE receives a PSSCH in a resource pool and the HARQ feedback enabled/disabled indicator field in the associated SCI indicates HARQ feedback is enabled, the UE provides the HARQ feedback information in a PSFCH transmission in the resource pool. The UE shall transmit the PSFCH in a first slot that includes PSFCH resources and is at least a number of slots (denoted minGap_{PSFCH-PSSCH}) after a last slot of the PSSCH reception, and there are two options to determine the frequency domain PSFCH resources (in unit of PRB) on which the HARQ feedback for the received PSSCH shall be transmitted:
The frequency domain PSFCH resources are associated with the starting subchannel of the corresponding PSSCH (denoted PSSCHₛₜₐᵣₜ). In this case the number of PSFCH resources associated to the PSSCH is M_{PSFCH-subchannel}.
The frequency domain PSFCH resources are associated with all the subchannels of the corresponding PSSCH (denoted PSSCHₐₗₗ). In this case the number of PSFCH resources associated to the PSSCH is M_{PSFCH-subchannel}*N_{subchannel-PSSCH} where N_{subchannel-PSSCH} is the number of subchannels occupied by the corresponding PSSCH.

The first option is primarily for HARQ feedback for unicast transmission while the second option is primarily for HARQ feedback for groupcast transmission (in which case multiple HARQ feedbacks need to be transmitted for one groupcasted TB).

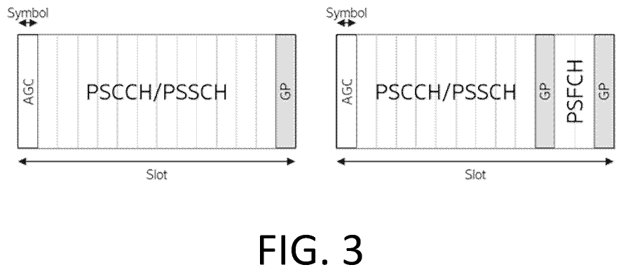

Multi-consecutive slots transmission (MCSt) is supported for both Mode 1 and Mode 2 resource allocation in sidelink on unlicensed spectrum (SL-U). With MCSt it is expected the number of LBT attempts can be decreased and the negative impact of LBT failure on transmission can be reduced. However, as shown in FIG. 3, due to the presence of GP and PSFCH occasion (where a Tx needs to monitor PSFCH and cannot transmit), consecutive transmission initiated by a UE would be interrupted. In this case, the UE may lose the channel if the gap period (e.g., the gap/guard OFDM symbol (OS), the Automatic Gain Control (AGC) OS for PSFCH and the PSFCH OS) is over the maximum gap period (e.g., 16 us) that the UE can skip LBT operation prior to subsequent transmissions. For example, in case the SL Subcarrier Spacing (SCS) is 15 kHz, the gap period may be up to 71 us×3=213 us. The UE would have to re-perform LBT operation to obtain the channel, and the benefit of MCSt will be reduced. In short, an improved solution of determining whether or not to skip a PSFCH occasion, in order to avoid unnecessary HARQ feedback transmission/reception in the skipped PSFCH occasion, and also avoid skipping too many consecutive PSFCH occasions which may lead to insufficient PSFCH resources and/or long HARQ feedback latency, is desired.

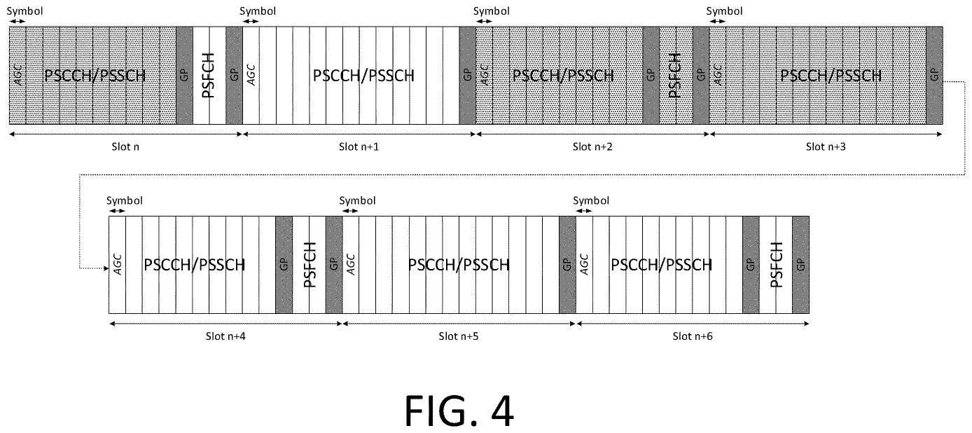

FIG. 4 is an example for avoidance of large number of consecutively skipped PSFCH occasions, where it is assumed that minGapPSFCH-PSSCH=2, period_{PSFCH}=2 and maxPSFCHoccasionₛₖᵢₚ=1. The shaded region means there is a PSCCH/PSSCH transmission scheduled/performed/detected in the slot(s).

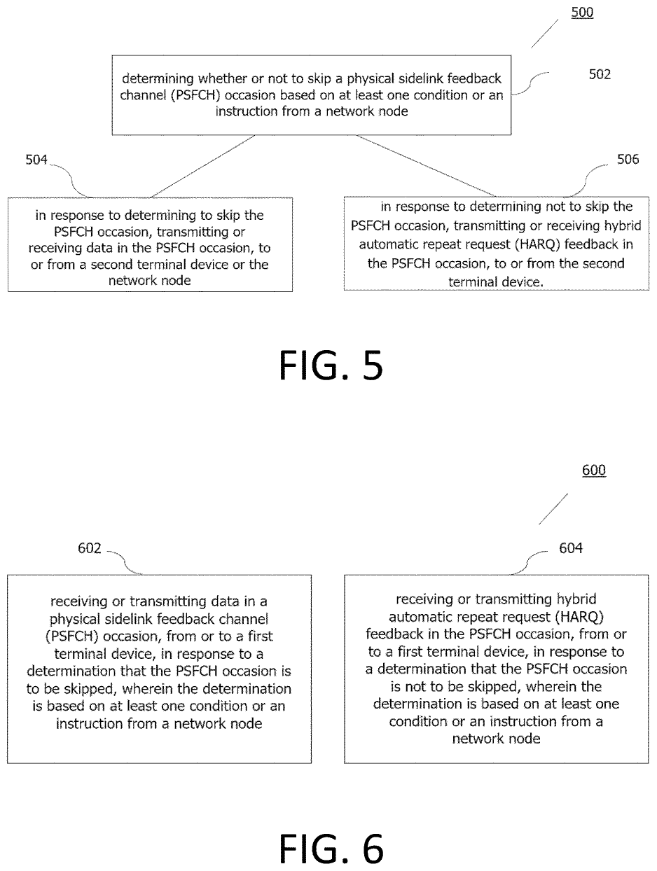

FIG. 5 is a flow chart of an exemplary method 500 implemented at a first terminal device (e.g. a UE) according to an embodiment of the present disclosure. The method 500 may comprise steps 502 and at least one of 504 and 506. However, the present disclosure is not limited thereto. In some other embodiments, the method 500 may comprise more steps, less steps, different steps, or any combination thereof. Further the steps of the method 500 may be performed in a different order than that described herein when multiple steps are involved. Further, in some embodiments, a step in the method 500 may be split into multiple sub-steps and performed by different entities, and/or multiple steps in the method 500 may be combined into a single step.

The method 500 may begin at step 502 to determine whether or not to skip a Physical Sidelink Feedback Channel (PSFCH) occasion during a Multi-Consecutive Slots transmission (MCSt) period, based on at least one condition or an instruction from a network node. Skipping a Physical Sidelink Feedback Channel (PSFCH) occasion means the terminal device will not transmit or receive HARQ feedback in the PSFCH occasion, and the PSFCH occasion can be used for data transmission and/or reception.

At step 504, in response to determining to skip the PSFCH occasion, the first terminal device transmits or receives data in the PSFCH occasion, to or from a second terminal device (e.g. a neighbor UE) or the network node (e.g. a gNB). When the first terminal device transmits or receives data in the PSFCH occasion to or from a second terminal device, it means the skipped PSFCH occasion is used for sidelink transmission and/or reception When the first terminal device transmits or receives data in the PSFCH occasion to or from the network node, it means the skipped PSFCH occasion is used for Uu interface transmission and reception.

At step 506, in response to determining not to skip the PSFCH occasion, the first terminal device transmits or receives Hybrid Automatic Repeat Request (HARQ) feedback in the PSFCH occasion, to or from the second terminal device.

In some embodiments, the PSFCH occasion is during a Multi-Consecutive Slots transmission (MCSt) period.

In some embodiments, the at least one condition is associated to one or multiple of: a Quality of Service (QOS) requirement for data of a service/traffic type/Logic Channel (LCH) in the MCSt period; a period for the first terminal device occupying a channel; remaining battery of the first terminal device; a priority of data/LCH associated to a HARQ feedback that the first terminal device expects to receive in the PSFCH occasion; a latency requirement of data/LCH associated to a HARQ feedback that the first terminal device expects to receive in the PSFCH occasion; a priority of data/LCH associated to a HARQ feedback that the first terminal device needs to transmit in the PSFCH occasion; a latency requirement of data/LCH associated to a HARQ feedback that the first terminal device needs to transmit in the PSFCH occasion; a maximum number of consecutive PSFCH occasions that are allowed to be skipped (maxPSFCHoccasionₛₖᵢₚ).

In some embodiments, the at least one condition for determining to skip the PSFCH occasion comprises one or multiple of: a priority of data of a service/traffic type/LCH in the MCSt period is greater than or equal to a priority threshold; a latency requirement of data of a service/traffic type/LCH in the MCSt period is less than or equal to a latency threshold; a queuing delay of data of a service/traffic type/LCH in the MCSt period is greater than or equal to a queuing delay threshold; a remaining packet delay budget of data of a service/traffic type/LCH in the MCSt period is less than or equal to a remaining packet delay budget threshold; a data volume of data of a service/traffic type/LCH in the MCSt period, which is pending for transmission, is greater than or equal to a data volume threshold; a period since the first terminal device has occupied the channel last time is less than or equal to a period threshold; remaining battery of the first terminal device is less than or equal to a battery threshold; the HARQ feedback that the first terminal device is expecting to receive in the PSFCH occasion is associated to data/LCH with priority less than or equal to a receiving HARQ feedback priority threshold; the HARQ feedback that the first terminal device is expecting to receive in the PSFCH occasion is associated to data/LCH with latency requirement greater than or equal to a receiving HARQ feedback latency threshold; the HARQ feedback that the first terminal device needs to transmit in the PSFCH occasion is associated to data/LCH with priority less than or equal to a transmitting HARQ feedback priority threshold; the HARQ feedback that the first terminal device needs to transmit in the PSFCH occasion is associated to data/LCH with latency requirement greater than or equal to a transmitting HARQ feedback latency threshold; a number of consecutive PSFCH occasions that has skipped is less than a maximum number of consecutive PSFCH occasions that are allowed to be skipped (maxPSFCHoccasionₛₖᵢₚ).

In some embodiments, the at least one condition for determining not to skip the PSFCH occasion comprises one or multiple of: a priority of data of a service/traffic type/LCH in the MCSt period is less than or equal to a priority threshold; a latency requirement of data of a service/traffic type/LCH in the MCSt period is greater than or equal to a latency threshold; a queuing delay of data of a service/traffic type/LCH in the MCSt period is less than or equal to a queuing delay threshold; a remaining packet delay budget of data of a service/traffic type/LCH in the MCSt period is greater than or equal to a remaining packet delay budget threshold; a data volume of data of a service/traffic type/LCH in the MCSt period, which is pending for transmission, is less than or equal to a data volume threshold; a period since the first terminal device has occupied the channel last time is greater than or equal to a period threshold; remaining battery of the first terminal device is greater than or equal to a battery threshold; the HARQ feedback that the first terminal device is expecting to receive in the PSFCH occasion is associated to data/LCH with priority greater than or equal to a receiving HARQ feedback priority threshold; the HARQ feedback that the first terminal device is expecting to receive in the PSFCH occasion is associated to data/LCH with latency requirement less than or equal to a receiving HARQ feedback latency threshold; the HARQ feedback that the first terminal device needs to transmit in the PSFCH occasion is ‘associated to data/LCH with priority greater than or equal to a transmitting HARQ feedback priority threshold; the HARQ feedback that the first terminal device needs to transmit in the PSFCH occasion is associated to data/LCH with latency requirement less than or equal to a transmitting HARQ feedback latency threshold; a number of consecutive PSFCH occasions that has skipped is greater than or equal to a maximum number of consecutive PSFCH occasions that are allowed to be skipped (maxPSFCHoccasionₛₖᵢₚ).

In some embodiments, the method further comprises: receiving a Downlink Control Indicator (DCI), Medium Access Control-Control Element (MAC-CE) or Radio Resource Control (RRC) signaling carrying the instruction from the network node.

In some embodiments, transmitting or receiving data in the PSFCH occasion comprises performing Physical Sidelink Shared Channel (PSSCH) or Physical Sidelink Control Channel (PSCCH) transmission or reception in full or part of the PSFCH occasion.

In some embodiments, the method further comprises: transmitting first information to a second terminal device via at least one of: PC5-S signaling; Discovery message; PC5-RRC signaling; sidelink MAC-CE; Sidelink Control Information (SCI); Layer 1 (L1) signaling.

In some embodiments, the method further comprises: transmitting second information to the network node via at least one of: Uu-RRC signaling; MAC-CE; Layer 1 (L1) signaling.

For a UE in mode 1, the gNB may determine whether a PSFCH occasion in the granted resources can be skipped and inform the determination to the UE using DCI, MAC-CE or RRC signaling. The determination may be made based on the reported SL BSR, e.g., a PSFCH occasion may be skipped if, according to the received SL BSR, the LCH priority of the pending SL traffic is above a priority threshold, and/or the queuing delay of the pending SL traffic is above a threshold, and/or the data volume of the pending SL traffic is above a threshold.

For those skipped PSFCH occasions, the UE may fully or partly occupy them for other transmission such as PSSCH transmission thus the gap between transmissions within the MCSt period is no larger than a gap period (e.g., 16 us) below which the UE can skip LBT operation prior to subsequent transmissions.

In some embodiments, the first information or second information comprises at least one of: a resource pool/Listen Before Talk (LBT) band in which the PSFCH occasion is recommended/allowed to be skipped; a slot in which the first terminal device has determined that the PSFCH occasion will be skipped; the at least one condition for skipping the PSFCH occasion; the determination that the PSFCH occasion is to be skipped or not to be skipped for the first terminal device; a recommendation that the PSFCH occasion is to be skipped or not to be skipped for the second terminal device; the maximum number of consecutive PSFCH occasions that are allowed to be skipped (maxPSFCHoccasionₛₖᵢₚ). The first terminal device can control the second terminal device by indicating the determination that the PSFCH occasion is to be skipped or not to be skipped for the first terminal device, therefore requires the second terminal device to perform accordingly, or just provide recommendation to the second terminal device by indicating a recommendation that the PSFCH occasion is to be skipped or not to be skipped for the second terminal device, in this case, the second terminal device can decide whether or not to skip the PSFCH occasion on its own and taking the recommendation as only reference.

Upon receiving the signaling, a neighbor UE may perform one or more of the below actions: 1) The neighbor UE will skip monitoring PSFCH expected from the UE in PSFCH occasion(s) which are recommended to be skipped by the UE. 2) The neighbor UE will not transmit PSFCH to the UE using PSFCH occasion(s) which are recommended to be skipped by the UE. 3) The neighbor UE postpones its PSFCH reception from the UE or PSFCH transmission to the UE to a later available PSFCH occasion (i.e., not recommended to be skipped by the UE).

Upon receiving the signaling, the gNB may perform at least one of the below actions: 1) Forward the signaling to other UEs in the cell via e.g., system information, Uu RRC signaling, MAC CE, or L1 signaling (carried on channels including Physical Downlink Control Channel (PDCCH), Physical Downlink Shared Channel (PDSCH) etc). 2) Reconfigure PSFCH occasions in the indicated resource pool or LBT band. For instance, less often PSFCH occasions may be configured in time domain to reduce the probability that PSFCH occasions have to be skipped to perform MCSt. Meanwhile, more PSFCH resources in frequency domain may be configured to avoid that the PSFCH resources become insufficient for PSFCH transmission/reception. The gNB may only perform the reconfiguration when having received the signaling from a certain number of UEs and all the signaling indicate that at least a certain number of PSFCH occasions need to be skipped.

In some embodiments, the maximum number of consecutive PSFCH occasions that are allowed to be skipped (maxPSFCHoccasionₛₖᵢₚ) is configured per at least one of: resource pool, LBT band, transmitting (Tx) terminal device, receiving (Rx) terminal device, QoS profile (for instance, different latency requirement having different maxPSFCHoccasionₛₖᵢₚ), Resource Block (RB)/LCH (for instance, different RB/LCH having different maxPSFCHoccasionₛₖᵢₚ).

The different levels can be applied jointly, e.g., Per resource pool & (Tx) UE, which means a (Tx) UE may be (pre)configured with different maxPSFCHoccasionₛₖᵢₚ in different pools, or Per resource pool & RB/LCH, which means a RB/LCH may be (pre)configured with different maxPSFCHoccasionₛₖᵢₚ in different pools, and so forth.

In another example, multiple maxPSFCHoccasionₛₖᵢₚ corresponding to different levels may be (pre)configured, for instance, one per resource pool maxPSFCHoccasionₛₖᵢₚ and one per Tx UE maxPSFCHoccasionₛₖᵢₚ and one per RB/LCH maxPSFCHoccasionₛₖᵢₚ, etc. The per pool maxPSFCHoccasionₛₖᵢₚ should preferably have the largest value.

In a sub-embodiment, a UE may inform one or more of the above maxPSFCHoccasionₛₖᵢₚ to another UE using e.g., PC5-RRC, SL MAC CE, SCI, etc. Different maxPSFCHoccasionₛₖᵢₚ may be informed using different signaling, e.g., per pool/LBT band maxPSFCHoccasionₛₖᵢₚ is informed using PC5-RRC or SL MAC CE, per Rx UE maxPSFCHoccasionₛₖᵢₚ is informed in SCI, etc. A UE may obtain per Rx UE maxPSFCHoccasionₛₖᵢₚ from another UE, and, when transmit to that UE, include the per Rx UE maxPSFCHoccasionₛₖᵢₚ of that UE in the SCI.

In another sub-embodiment, (per pool/LBT band) M_{PSFCH-subchannel} is set to M_{PSFCH}/(N_{subchannel-pool/LBT band}*((per pool/LBT band) maxPSFCHoccasionₛₖᵢₚ+1)*period_{PSFCH}), by this it can be guaranteed that there is no conflict in PSFCH transmission (in a resource pool or LBT band) as long as the number of consecutively skipped PSFCH occasions does not exceed maxPSFCHoccasionₛₖᵢₚ (of that resource pool or LBT band).

In some embodiments, when the first terminal device is a Tx terminal device, and for per resource pool or per LBT band maxPSFCHoccasionₛₖᵢₚ, the method further comprises: taking a number of consecutively skipped PSFCH occasions in a resource pool or a LBT band into account, when performing resource selection/reselection, or when determining how to perform transmission using the obtained resource, so that the number of consecutively skipped PSFCH occasions in that resource pool or LBT band does not exceed the maxPSFCHoccasionₛₖᵢₚ of the resource pool or LBT band, where HARQ feedback is expected to be transmitted in those consecutively skipped PSFCH occasions. Taking FIG. 4 as example, the Tx UE detected a SCI in slot n which is transmitted from another UE and which indicates HARQ feedback is enabled, and according to the minGap_{PSFCH-PSSCH}, the HARQ feedback is expected to be transmitted to the other UE in slot n+2. However, in slot n+2, the Tx UE detected another SCI which indicates the HARQ occasion in this slot cannot be used due to e.g., there is a MCSt in slots n+2 and n+3, as according to the maxPSFCHoccasionₛₖᵢₚ only one HARQ occasion can be skipped for the resource pool or LBT band, in mode 2, the Tx UE may select resources in other resource pool or LBT band(s) for its transmission or avoid selecting resources leading to that the next PSFCH occasion in slot n+4 in the resource pool or LBT band has also to be skipped by the other UE, for instance, the Tx UE avoids selecting resources in slots n+4 and n+5 to perform MCSt. In mode 1, the Tx UE selects to not perform MCSt even if it is granted resources in slots n+4 and n+5.

In some embodiments, when the first terminal device is a Tx terminal device and for per Tx terminal device maxPSFCHoccasionₛₖᵢₚ the method further comprises: taking a number of consecutively skipped PSFCH occasions where the first terminal device needs to monitor HARQ feedback into account, when performing selection/reselection, or when determining how to perform transmission using the obtained resources, so that the number of consecutively skipped PSFCH occasions does not exceed the maxPSFCHoccasionₛₖᵢₚ of the first terminal device. Also taking FIG. 4 as example, the Tx UE has performed a transmission requiring HARQ feedback in slot n, and according to the minGap_{PSFCH-PSSCH}, the Tx UE can receive the HARQ feedback in slot n+2 if the HARQ occasion is not skipped. However, the Tx UE has performed a MCSt in slots n+2 and n+3 thus cannot monitor HARQ occasion in slot n+2, as according to the maxPSFCHoccasionskip only one HARQ occasion can be skipped for the Tx UE, in mode 2, the Tx UE avoids selecting resources leading to that it cannot monitor PSFCH in the next PSFCH occasion in slot n+4, for instance, the Tx UE avoids selecting resources in slots n+4 and n+5 to perform MCSt. In mode 1, the Tx UE selects to not perform MCSt even if it is granted resources in slots n+4 and n+5.

In some embodiments, when the first terminal device is a Tx terminal device and for per Rx terminal device maxPSFCHoccasionₛₖᵢₚ, the method further comprises: taking a number of consecutively skipped PSFCH occasions where the Rx terminal device needs to transmit HARQ feedback into account when performing transmissions, so that the number of consecutively skipped PSFCH occasions does not exceed the maxPSFCHoccasionₛₖᵢₚ of the Rx terminal device. Also taking FIG. 4 as example, the Tx UE detected a SCI in slot n which is transmitted from another Tx UE and which indicates transmission to an Rx UE and HARQ feedback is enabled, and according to the minGap_{PSFCH-PSSCH}, the Rx UE may send HARQ feedback in slot n+2. However, in slot n+2, the Tx UE detected another SCI which indicates the Rx UE cannot send HARQ feedback in the HARQ occasion in this slot due to e.g., there is a MCSt to the Rx UE in slots n+2 and n+3, as according to the maxPSFCHoccasionₛₖᵢₚ only one HARQ occasion can be skipped for the Rx UE, the Tx UE avoids transmission leading to that the Rx UE cannot send HARQ feedback in the next PSFCH occasion in slot n+4, for instance, in case the Tx UE performs MCSt in slots n+4 and n+5, it excludes the Rx UE in destination selection so that it will not transmit to the Rx UE leading to that the Rx UE has to receive and cannot transmit in the PSFCH occasion.

In some embodiments, when the first terminal device is a Tx terminal device and for per QoS profile or RB/LCH maxPSFCHoccasionₛₖᵢₚ, the method further comprises: taking a number of consecutively skipped PSFCH occasions where the first terminal device needs to monitor HARQ feedback into account, when performing selection/reselection, or when determining how to perform transmission using the obtained resources, so that the number of consecutively skipped PSFCH occasions does not exceed the maxPSFCHoccasionₛₖᵢₚ of the first terminal device.

In some embodiments, the maxPSFCHoccasionₛₖᵢₚ is determined based on QoS profile of the transmitted data or the RB/LCH.

In some embodiments, the maxPSFCHoccasionₛₖᵢₚ is determined as the maxPSFCHoccasionₛₖᵢₚ with the smallest value among the multiple per QoS profile or RB/LCH maxPSFCHoccasionₛₖᵢₚ.

In some embodiments, the method further comprises: updating the maxPSFCHoccasionₛₖᵢₚ when the service is started/stopped or the RB/LCH is configured/reconfigured.

In case multiple maxPSFCHoccasionₛₖᵢₚ corresponding to different levels are (pre)configured, the gNB/Tx UE may determine how the transmission is scheduled/performed for each maxPSFCHoccasionₛₖᵢₚ according to the above embodiments, and makes a final decision based on all these determinations. For instance, if at least one determination indicates that a UE cannot perform MCSt in certain slots, the MCSt will not be performed, so to determine whether or not to skip PSFCH when there are multiple maxPSFCHoccasionₛₖᵢₚ.

FIG. 6 is a flow chart of an exemplary method 600 implemented at a second terminal device according to an embodiment of the present disclosure. The method 600 may comprise steps 602 and/or 604. However, the present disclosure is not limited thereto. In some other embodiments, the method 600 may comprise more steps, less steps, different steps, or any combination thereof. Further the steps of the method 600 may be performed in a different order than that described herein when multiple steps are involved. Further, in some embodiments, a step in the method 600 may be split into multiple sub-steps and performed by different entities, and/or multiple steps in the method 600 may be combined into a single step.

The method 600 may begin at step 602 to receive or transmit data in a Physical Sidelink Feedback Channel (PSFCH) occasion, from or to a first terminal device, in response to a determination that the PSFCH occasion is to be skipped, and/or at step 604 to receive or transmit Hybrid Automatic Repeat Request (HARQ) feedback in the PSFCH occasion, from or to a first terminal device, in response to a determination that the PSFCH occasion is not to be skipped. The determination is based on at least one condition or an instruction from a network node.

In some embodiments, the PSFCH occasion is during a Multi-Consecutive Slots transmission (MCSt) period.

In some embodiments, the at least one condition is associated to one or multiple of: a Quality of Service (QOS) requirement for data of a service/traffic type/Logic Channel (LCH) in the MCSt period; a period for the first terminal device occupying a channel; remaining battery of the first terminal device; a priority of data/LCH associated to a HARQ feedback that the first terminal device expects to receive in the PSFCH occasion; a latency requirement of data/LCH associated to a HARQ feedback that the first terminal device expects to receive in the PSFCH occasion; a priority of data/LCH associated to a HARQ feedback that the first terminal device needs to transmit in the PSFCH occasion; a latency requirement of data/LCH associated to a HARQ feedback that the first terminal device needs to transmit in the PSFCH occasion; a maximum number of consecutive PSFCH occasions that are allowed to be skipped (maxPSFCHoccasionskip).

In some embodiments, the at least one condition for determining to skip the PSFCH occasion comprises one or multiple of: a priority of data of a service/traffic type/LCH in the MCSt period is greater than or equal to a priority threshold; a latency requirement of data of a service/traffic type/LCH in the MCSt period is less than or equal to a latency threshold; a queuing delay of data of a service/traffic type/LCH in the MCSt period is greater than or equal to a queuing delay threshold; a remaining packet delay budget of data of a service/traffic type/LCH in the MCSt period is less than or equal to a remaining packet delay budget threshold; a data volume of data of a service/traffic type/LCH in the MCSt period, which is pending for transmission, is greater than or equal to a data volume threshold; a period since the first terminal device has occupied the channel last time is less than or equal to a period threshold; remaining battery of the first terminal device is less than or equal to a battery threshold; the HARQ feedback that the first terminal device is expecting to receive in the PSFCH occasion is associated to data/LCH with priority less than or equal to a receiving HARQ feedback priority threshold; the HARQ feedback that the first terminal device is expecting to receive in the PSFCH occasion is associated to data/LCH with latency requirement greater than or equal to a receiving HARQ feedback latency threshold; the HARQ feedback that the first terminal device needs to transmit in the PSFCH occasion is associated to data/LCH with priority less than or equal to a transmitting HARQ feedback priority threshold; the HARQ feedback that the first terminal device needs to transmit in the PSFCH occasion is associated to data/LCH with latency requirement greater than or equal to a transmitting HARQ feedback latency threshold; a number of consecutive PSFCH occasions that has skipped is less than a maximum number of consecutive PSFCH occasions that are allowed to be skipped (maxPSFCHoccasionₛₖᵢₚ).

In some embodiments, the at least one condition for determining not to skip the PSFCH occasion comprises one or multiple of: a priority of data of a service/traffic type/LCH in the MCSt period is less than or equal to a priority threshold; a latency requirement of data of a service/traffic type/LCH in the MCSt period is greater than or equal to a latency threshold; a queuing delay of data of a service/traffic type/LCH in the MCSt period is less than or equal to a queuing delay threshold; a remaining packet delay budget of data of a service/traffic type/LCH in the MCSt period is greater than or equal to a remaining packet delay budget threshold; a data volume of data of a service/traffic type/LCH in the MCSt period, which is pending for transmission, is less than or equal to a data volume threshold; a period since the first terminal device has occupied the channel last time is greater than or equal to a period threshold; remaining battery of the first terminal device is greater than or equal to a battery threshold; the HARQ feedback that the first terminal device is expecting to receive in the PSFCH occasion is associated to data/LCH with priority greater than or equal to a receiving HARQ feedback priority threshold; the HARQ feedback that the first terminal device is expecting to receive in the PSFCH occasion is associated to data/LCH with latency requirement less than or equal to a receiving HARQ feedback latency threshold; the HARQ feedback that the first terminal device needs to transmit in the PSFCH occasion is associated to data/LCH with priority greater than or equal to a transmitting HARQ feedback priority threshold; the HARQ feedback that the first terminal device needs to transmit in the PSFCH occasion is associated to data/LCH with latency requirement less than or equal to a transmitting HARQ feedback latency threshold; a number of consecutive PSFCH occasions that has skipped is greater than or equal to a maximum number of consecutive PSFCH occasions that are allowed to be skipped (maxPSFCHoccasionₛₖᵢₚ).

In some embodiments, the method further comprises: receiving or transmitting data in the PSFCH occasion comprises performing Physical Sidelink Shared Channel (PSSCH) or Physical Sidelink Control Channel (PSCCH) reception or transmission in full or part of the PSFCH occasion.

In some embodiments, the method further comprises: receiving first information from the first terminal device via at least one of: PC5-S signaling; Discovery message; PC5-RRC signaling; sidelink MAC-CE; Sidelink Control Information (SCI); Layer 1 (L1) signaling.

In some embodiments, the first information comprises at least one of: a resource pool/Listen Before Talk (LBT) band in which the PSFCH occasion is recommended/allowed to be skipped; a slot in which the first terminal device has determined that the PSFCH occasion will be skipped; the at least one condition for skipping the PSFCH occasion; the determination that the PSFCH occasion is to be skipped or not to be skipped for the first terminal device; a recommendation that the PSFCH occasion is to be skipped or not to be skipped for the second terminal device; the maximum number of consecutive PSFCH occasions that are allowed to be skipped (maxPSFCHoccasionₛₖᵢₚ).

In some embodiments, the method further comprises: at least one of: skipping monitoring the HARQ feedback expected from the first terminal device in the PSFCH occasion which is determined to be skipped by the first terminal device and/or recommended to be skipped for the second terminal device; skipping transmitting the HARQ feedback to the first terminal device in the PSFCH occasion which is determined to be skipped by the first terminal device and/or recommended to be skipped for the second terminal device; postponing the HARQ feedback reception from the first terminal device or HARQ feedback transmission to the first terminal device, to a later available PSFCH occasion.

In some embodiments, the maximum number of consecutive PSFCH occasions that are allowed to be skipped (maxPSFCHoccasionₛₖᵢₚ) is configured per at least one of: resource pool, LBT band, transmitting (Tx) terminal device, receiving (Rx) terminal device, QoS profile, Resource Block (RB)/LCH.

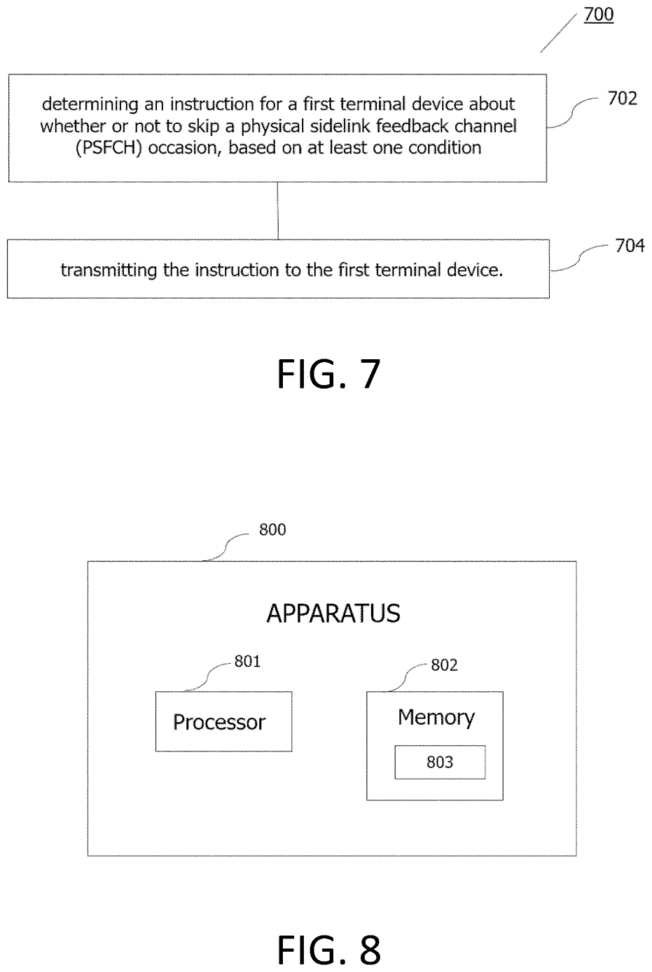

FIG. 7 is a flow chart of an exemplary method 700 implemented at a network node according to an embodiment of the present disclosure. The method 700 may comprise steps 702 and 704. However, the present disclosure is not limited thereto. In some other embodiments, the method 700 may comprise more steps, less steps, different steps, or any combination thereof. Further the steps of the method 700 may be performed in a different order than that described herein when multiple steps are involved. Further, in some embodiments, a step in the method 700 may be split into multiple sub-steps and performed by different entities, and/or multiple steps in the method 700 may be combined into a single step.

The method 700 may begin at step 702 to determine an instruction for a first terminal device about whether or not to skip a Physical Sidelink Feedback Channel (PSFCH) occasion during a Multi-Consecutive Slots transmission (MCSt) period, based on at least one condition.

At step 704, the network node transmits the instruction to the first terminal device.

In some embodiments, the method further comprises: receiving or transmitting data in the PSFCH occasion, from or to the first terminal device, in response to a determination that the PSFCH occasion is to be skipped. When the network node receives or transmits data in the PSFCH occasion, from or to the first terminal device, it means the skipped PSFCH occasion is used for Uu interface transmission and reception.

In some embodiments, the PSFCH occasion is during a Multi-Consecutive Slots transmission (MCSt) period.

In some embodiments, the at least one condition is associated to one or multiple of: a Quality of Service (QOS) requirement for data of a service/traffic type/Logic Channel (LCH) in the MCSt period; a period for the first terminal device occupying a channel; remaining battery of the first terminal device; a priority of data/LCH associated to a HARQ feedback that the first terminal device expects to receive in the PSFCH occasion; a latency requirement of data/LCH associated to a HARQ feedback that the first terminal device expects to receive in the PSFCH occasion; a priority of data/LCH associated to a HARQ feedback that the first terminal device needs to transmit in the PSFCH occasion; a latency requirement of data/LCH associated to a HARQ feedback that the first terminal device needs to transmit in the PSFCH occasion; a maximum number of consecutive PSFCH occasions that are allowed to be skipped (maxPSFCHoccasionskip).

In some embodiments, the at least one condition for determining to skip the PSFCH occasion comprises one or multiple of: a priority of data of a service/traffic type/LCH in the MCSt period is greater than or equal to a priority threshold; a latency requirement of data of a service/traffic type/LCH in the MCSt period is less than or equal to a latency threshold; a queuing delay of data of a service/traffic type/LCH in the MCSt period is greater than or equal to a queuing delay threshold; a remaining packet delay budget of data of a service/traffic type/LCH in the MCSt period is less than or equal to a remaining packet delay budget threshold; a data volume of data of a service/traffic type/LCH in the MCSt period, which is pending for transmission, is greater than or equal to a data volume threshold; a period since the first terminal device has occupied the channel last time is less than or equal to a period threshold; remaining battery of the first terminal device is less than or equal to a battery threshold; the HARQ feedback that the first terminal device is expecting to receive in the PSFCH occasion is associated to data/LCH with priority less than or equal to a receiving HARQ feedback priority threshold; the HARQ feedback that the first terminal device is expecting to receive in the PSFCH occasion is associated to data/LCH with latency requirement greater than or equal to a receiving HARQ feedback latency threshold; the HARQ feedback that the first terminal device needs to transmit in the PSFCH occasion is associated to data/LCH with priority less than or equal to a transmitting HARQ feedback priority threshold; the HARQ feedback that the first terminal device needs to transmit in the PSFCH occasion is associated to data/LCH with latency requirement greater than or equal to a transmitting HARQ feedback latency threshold; a number of consecutive PSFCH occasions that has skipped is less than a maximum number of consecutive PSFCH occasions that are allowed to be skipped (maxPSFCHoccasionₛₖᵢₚ).

In some embodiments, the at least one condition for determining not to skip the PSFCH occasion comprises one or multiple of: a priority of data of a service/traffic type/LCH in the MCSt period is less than or equal to a priority threshold; a latency requirement of data of a service/traffic type/LCH in the MCSt period is greater than or equal to a latency threshold; a queuing delay of data of a service/traffic type/LCH in the MCSt period is less than or equal to a queuing delay threshold; a remaining packet delay budget of data of a service/traffic type/LCH in the MCSt period is greater than or equal to a remaining packet delay budget threshold; a data volume of data of a service/traffic type/LCH in the MCSt period, which is pending for transmission, is less than or equal to a data volume threshold; a period since the first terminal device has occupied the channel last time is greater than or equal to a period threshold; remaining battery of the first terminal device is greater than or equal to a battery threshold; the HARQ feedback that the first terminal device is expecting to receive in the PSFCH occasion is associated to data/LCH with priority greater than or equal to a receiving HARQ feedback priority threshold; the HARQ feedback that the first terminal device is expecting to receive in the PSFCH occasion is associated to data/LCH with latency requirement less than or equal to a receiving HARQ feedback latency threshold; the HARQ feedback that the first terminal device needs to transmit in the PSFCH occasion is associated to data/LCH with priority greater than or equal to a transmitting HARQ feedback priority threshold; the HARQ feedback that the first terminal device needs to transmit in the PSFCH occasion is associated to data/LCH with latency requirement less than or equal to a transmitting HARQ feedback latency threshold; a number of consecutive PSFCH occasions that has skipped is greater than or equal to a maximum number of consecutive PSFCH occasions that are allowed to be skipped (maxPSFCHoccasionₛₖᵢₚ).

In some embodiments, the instruction is carried in a Downlink Control Indicator (DCI), Medium Access Control-Control Element (MAC-CE) or Radio Resource Control (RRC) signaling.

In some embodiments, the method further comprises: receiving or transmitting data in the PSFCH occasion comprises performing Physical Sidelink Shared Channel (PSSCH) or Physical Sidelink Control Channel (PSCCH) reception or transmission in full or part of the PSFCH occasion.

In some embodiments, the method further comprises: receiving second information from the first terminal device via at least one of: Uu-RRC signaling; MAC-CE; Layer 1 (L1) signaling.

In some embodiments, the second information comprises at least one of: a resource pool/Listen Before Talk (LBT) band in which the PSFCH occasion is recommended/allowed to be skipped; a slot in which the first terminal device has determined that the PSFCH occasion will be skipped; the at least one condition for skipping the PSFCH occasion; the determination that the PSFCH occasion is to be skipped or not to be skipped for the first terminal device; a recommendation that the PSFCH occasion is to be skipped or not to be skipped for the second terminal device; the maximum number of consecutive PSFCH occasions that are allowed to be skipped (maxPSFCHoccasionₛₖᵢₚ).

In some embodiments, the method further comprises at least one of: forwarding the second information to a second terminal device; reconfiguring the PSFCH occasion in the resource pool or LBT band.

In some embodiments, the determination is further based on sidelink (SL) Buffer Status Report (BSR) received from the first terminal device.

In some embodiments, the maximum number of consecutive PSFCH occasions that are allowed to be skipped (maxPSFCHoccasionₛₖᵢₚ) is configured per at least one of: resource pool, LBT band, transmitting (Tx) terminal device, receiving (Rx) terminal device, QoS profile, Resource Block (RB)/LCH.

In some embodiments, for per resource pool or per LBT band maxPSFCHoccasionₛₖᵢₚ, the method further comprises: taking a number of consecutively skipped PSFCH occasions in a resource pool or a LBT band into account, when performing sidelink resource allocation, so that the number of consecutively skipped PSFCH occasions in that resource pool or LBT band does not exceed the maxPSFCHoccasionₛₖᵢₚ of the resource pool or LBT band. One way to implement this is that in case consecutively skipped PSFCH occasions in a resource pool or a LBT band equals maxPSFCHoccasionₛₖᵢₚ, the gNB schedules transmission in other resource pool or LBT band(s), or avoids scheduling a transmission leading to that the next PSFCH occasion in the resource pool or LBT band has also to be skipped, for instance, the gNB avoids scheduling a MCSt in the resource pool or LBT band where the slot containing the next PSFCH occasion is a non-last slot of the MCSt. The gNB may indicate in DCI whether MCSt is allowed in the granted resources or whether a PSFCH occasion can be skipped.

In some embodiments, for per Tx terminal device maxPSFCHoccasionₛₖᵢₚ the method further comprises: taking a number of consecutively skipped PSFCH occasions where the first terminal device needs to monitor HARQ feedback (if the PSFCH occasion is not skipped) into account, when performing sidelink resource allocation, so that the number of consecutively skipped PSFCH occasions does not exceed the maxPSFCHoccasionₛₖᵢₚ of the first terminal device. Also taking FIG. 4 as example, the gNB has scheduled a UE to perform a SL transmission in slot n, and according to the minGap_{PSFCH-PSSCH}, the UE may expect HARQ feedback in slot n+2 (if HARQ feedback is enabled by the UE). Meanwhile, the gNB has also scheduled the UE to perform a MCSt in slots n+2 and n+3, consequently the UE cannot monitor PSFCH in slot n+2, as according to the maxPSFCHoccasionₛₖᵢₚ only one HARQ occasion can be skipped for the UE, the gNB avoids scheduling the UE to perform a transmission leading to that the UE cannot monitor PSFCH in the next PSFCH occasion (i.e., PSFCH occasion in slot n+4 in the figure), for instance, the gNB avoids scheduling the UE to perform a MCSt in slots n+4 and n+5. The gNB may indicate in DCI sent to the UE whether MCSt is allowed in the granted resources or whether a PSFCH occasion can be skipped.

In some embodiments, for per Rx terminal device maxPSFCHoccasionₛₖᵢₚ, the method further comprises: taking a number of consecutively skipped PSFCH occasions where the Rx terminal device needs to transmit HARQ feedback into account when performing transmissions, so that the number of consecutively skipped PSFCH occasions does not exceed the maxPSFCHoccasionₛₖᵢₚ of the Rx terminal device.

In some embodiments, when the first terminal device is a Tx terminal device and for per QoS profile or RB/LCH maxPSFCHoccasionₛₖᵢₚ, the method further comprises: taking a number of consecutively skipped PSFCH occasions where the first terminal device needs to monitor HARQ feedback into account, when sidelink resource allocation, so that the number of consecutively skipped PSFCH occasions does not exceed the maxPSFCHoccasionₛₖᵢₚ of the first terminal device.

In some embodiments, the maxPSFCHoccasionₛₖᵢₚ is determined based on QoS profile of the transmitted data or the RB/LCH.

In some embodiments, the maxPSFCHoccasionₛₖᵢₚ is determined as the maxPSFCHoccasionₛₖᵢₚ with the smallest value among the multiple per QoS profile or RB/LCH maxPSFCHoccasionₛₖᵢₚ.

In some embodiments, the method further comprises: updating the maxPSFCHoccasionₛₖᵢₚ when the service is started/stopped or the RB/LCH is configured/reconfigured.

In case multiple maxPSFCHoccasionₛₖᵢₚ corresponding to different levels are (pre)configured, the gNB/Tx UE may determine how the transmission be scheduled/performed for each maxPSFCHoccasionₛₖᵢₚ according to the above embodiments, and makes a final decision based on all these determinations. For instance, if at least one determination indicates that a UE cannot perform MCSt in certain slots, the MCSt will not be performed, so to determine whether or not to skip PSFCH when there are multiple maxPSFCHoccasionₛₖᵢₚ.

FIG. 8 is block diagram illustrating an apparatus 800 according to various embodiments of the present disclosure. As shown in FIG. 8, the apparatus 800 may comprise one or more processors such as processor 801, and one or more memories such as memory 802, storing computer program codes 803. The memory 802 may be non-transitory machine/processor/computer readable storage medium. In accordance with some exemplary embodiments, the apparatus 800 may be implemented as an integrated circuit chip or module that can be plugged or installed into a first terminal device as described with respect to FIG. 5, a second terminal device as described with respect to FIG. 6, and/or a network node as described with respect to FIG. 7.

In some implementations, the one or more memories 802, and the computer program codes 803, may be configured to, with the one or more processors 801, cause the apparatus 800 at least to perform any operation of the method as described in connection with FIG. 5, FIG. 6 and FIG. 7. In other implementations, the one or more memories 802, and the computer program codes 803, may be configured to, with the one or more processors 801, cause the apparatus 800 at least to perform any operation of the method as described in connection with FIG. 5, FIG. 6 and FIG. 7.

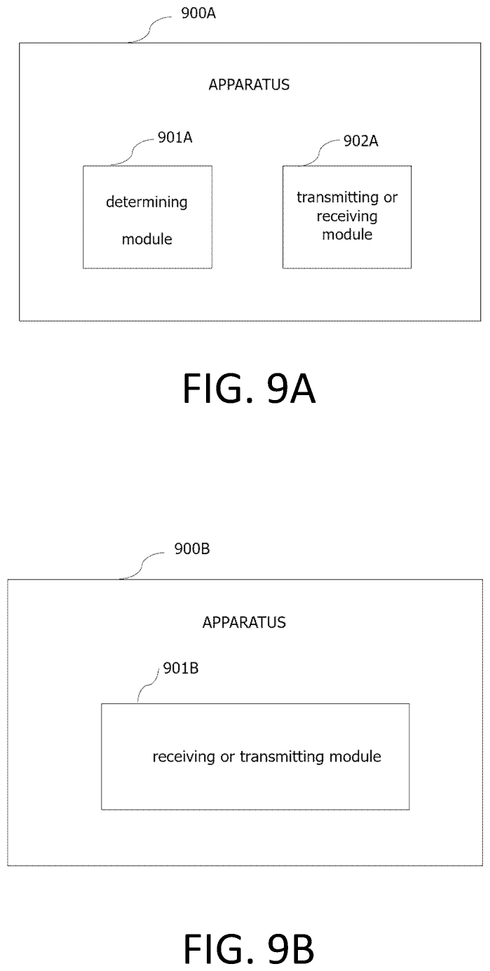

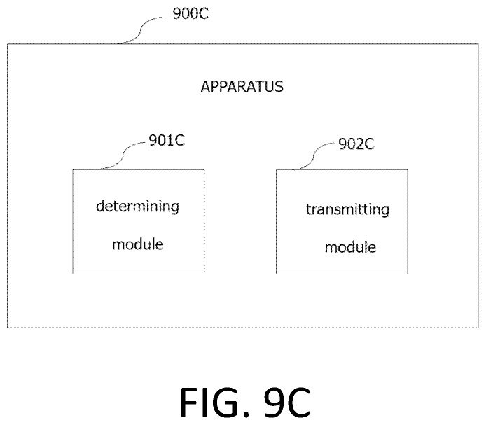

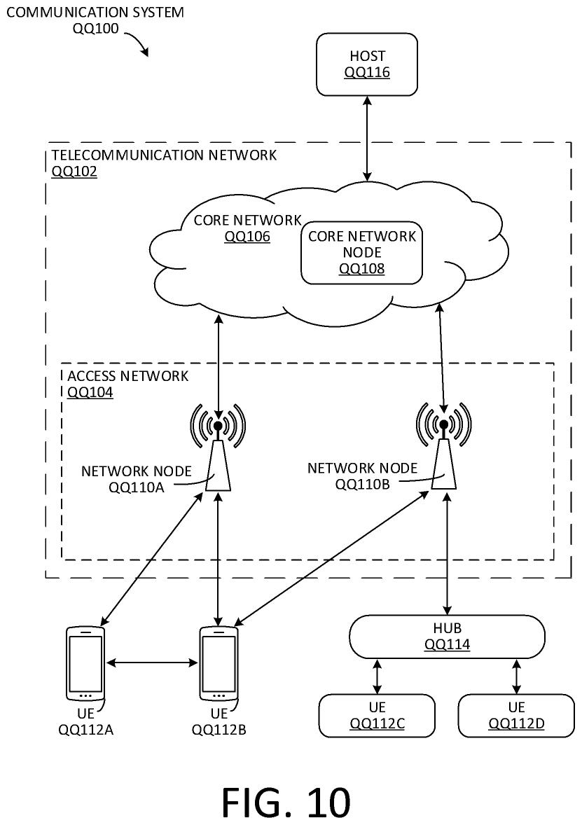

Correspondingly to the method 500 as described above, an exemplary apparatus implemented in a first terminal device is provided. FIG. 9A is a block diagram of the apparatus 900A according to an embodiment of the present disclosure. The apparatus 900A may be, e.g., the TX UE or RX UE in some embodiments.

The apparatus 900A may be configured to perform the method 500 as described above in connection with FIG. 5. As shown in FIG. 9A, the apparatus 900A may comprise: a determining module 901A configured to determine whether or not to skip a Physical Sidelink Feedback Channel (PSFCH) occasion, based on at least one condition or an instruction from a network node; and a transmitting or receiving module 902A configured to, in response to determining to skip the PSFCH occasion, transmit or receive data in the PSFCH occasion, to or from a second terminal device or the network node, or in response to determining not to skip the PSFCH occasion, transmit or receive Hybrid Automatic Repeat Request (HARQ) feedback in the PSFCH occasion, to or from the second terminal device.

The above modules 901A and/or 902A may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5. Further, the apparatus 900A may comprise one or more further modules, each of which may perform any of the steps of the method 500 described with reference to FIG. 5.

Correspondingly to the method 600 as described above, an exemplary apparatus implemented in a second terminal device is provided. FIG. 9B is a block diagram of the apparatus 900B according to an embodiment of the present disclosure. The apparatus 900B may be, e.g., the RX UE or TX UE in some embodiments.

The apparatus 900B may be configured to perform the method 600 as described above in connection with FIG. 6. As shown in FIG. 9B, the apparatus 900B may comprise: a receiving or transmitting module 901B configured to receive or transmit data in a Physical Sidelink Feedback Channel (PSFCH) occasion, from or to a first terminal device, in response to a determination that the PSFCH occasion is to be skipped; and/or receive or transmit Hybrid Automatic Repeat Request (HARQ) feedback in the PSFCH occasion, from or to a first terminal device, in response to a determination that the PSFCH occasion is not to be skipped. The determination is based on at least one condition or an instruction from a network node.

The above module 910B may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 6. Further, the apparatus 900B may comprise one or more further modules, each of which may perform any of the steps of the method 600 described with reference to FIG. 6.

Correspondingly to the method 700 as described above, an apparatus implemented in a network node is provided. FIG. 9C is a block diagram of apparatus 900C according to an embodiment of the present disclosure. The apparatus 900C may be, e.g., the gNB in some embodiments.

The apparatus 900C may be configured to perform the method 700 as described above in connection with FIG. 7. As shown in FIG. 9C, the apparatus 900C may comprise a determining module 901C configured to determine an instruction for a first terminal device about whether or not to skip a Physical Sidelink Feedback Channel (PSFCH) occasion, based on at least one condition; and a transmitting module 902C configured to transmit the instruction to the first terminal device.

The above modules 901C and/or 902C may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 7. Further, the apparatus 900C may comprise one or more further modules, each of which may perform any of the steps of the method 700 described with reference to FIG. 7.

Hereinafter, the solutions will be further described as follows.

In the 3GPP Rel. 18, a WI on sidelink enhancement has been approved (RP-213678, which is incorporated herein by reference in its entirety), and one of the objectives is to study and specify support of sidelink on unlicensed spectrum (SL-U).

It was agreed in RAN1 that Multi-consecutive slots transmission (MCSt) is supported for both Mode 1 and Mode 2 resource allocation in SL-U. With MCSt it is expected the number of LBT attempts can be decreased and the negative impact of LBT failure on transmission can be reduced. However, as shown in FIG. 3, due to the presence of GP and PSFCH occasion (where a Tx needs to monitor PSFCH and cannot transmit), consecutive transmission initiated by a UE would be interrupted. In this case, the UE may lose the channel if the gap period (e.g., the gap/guard OS, the AGC OS for PSFCH and the PSFCH OS) is over the maximum gap period (e.g., 16 us) that the UE can skip LBT operation prior to subsequent transmissions. For example, in case the SL SCS is 15 kHz, the gap period may be up to 71 us×3=213 us. The UE would have to re-perform LBT operation to obtain the channel, and the benefit of MCSt will be reduced.

The above issues will be discussed, and corresponding solutions will be developed in this application.

The application proposes mechanisms for a UE to determine whether to skip a PSFCH occasion (i.e., not transmit/receive PSFCH in that PSFCH occasion) during a MCSt period, corresponding signaling and actions of gNB/UE receiving the signaling. The application also proposes to introduce a maximum number of consecutive PSFCH occasion(s) that can be skipped and corresponding gNB/UE actions based on that new parameter.

The aspects of the application include the followings:
Conditions for a UE to determine whether or not to skip a PSFCH occasion.
Signaling to inform the skipped PSFCH occasion(s) to neighbor UE(s) and the corresponding neighbor UE(s) actions.
Signaling to inform the skipped PSFCH occasion(s) to gNB and the corresponding gNB actions.
Introduce a new parameter called maximum number of consecutive PSFCH occasion(s) that can be skipped.
gNB/UE actions based on the new parameter. The actions are different depending on at what level the parameter is defined.
gNB/UE actions with multiple maxpsfchoccasionₛₖᵢₚ at different levels.

With the proposed methods it can be determined properly whether or not a PSFCH occasion should be skipped, unnecessary PSFCH transmission/reception is avoided in skipped PSFCH occasion, and it is avoided to skip many consecutive PSFCH occasions which leads to insufficient PSFCH resources and/or long HARQ feedback latency.

The present disclosure is described in the context of NR sidelink (SL) communications in an unlicensed carrier. However, most of the embodiments are in general applicable to any kind of direct communications between UEs involving device-to-device (D2D) communications such as LTE SL. Embodiments are described from a Tx UE and Rx UE point of view. Further, it is assumed that a SL UE and its serving gNB (if the UE is in NW coverage) operates with the same radio access technology (RAT) e.g., NR, LTE, and so on. However, all the embodiments apply without loss of meaning to any combination of RATs between the SL UE and its serving gNB.

The link or radio link over which the signals are transmitted between at least two UEs for D2D operation is called herein as the sidelink (SL). The signals transmitted between the UEs for D2D operation are called herein as SL signals. The term SL may also interchangeably be called as D2D link, V2X link, prose link, peer-to-peer link, PC5 link etc. The SL signals may also interchangeably be called as V2X signals, D2D signals, prose signals, PC5 signals, peer-to-peer signals etc.

The term LBT may also interchangeably called as clear channel assessment (CCA), shared spectrum access procedure etc. The carrier on which the LBT is applied may belong to a shared spectrum or an unlicensed band or band with contention based access etc. The CCA based operation is more generally called contention-based operation. The transmission of signals on a carrier subjected to CCA is also called contention-based transmission. The contention-based operation is typically used for transmission on carriers of unlicensed frequency band. But this mechanism may also be applied for operating on carriers belonging to licensed band for example to reduce interference. The transmission of signals on a carrier which is not subjected to CCA is also called contention free transmission. LBT or CCA procedure can be performed by UE prior to a transmission and/or by a network node (e.g. base station) prior to a transmission.

In addition, both LBE based channel access schemes (may also be named as dynamic channel access) and FBE based channel access schemes (may also be named as semi static channel access) are covered in the following embodiments.

The following embodiments are applicable to SL transmissions with any cast type including unicast, groupcast and broadcast. For a SL BWP configured to the UE, the BWP may contain multiple bandwidth segments referred to as e.g., channel, sub-band, BWP segment etc., for each segment, it may be configured with the following different parameters
SCS
Symbol duration
Cyclic prefix (CP) length.

In this case, the UE may perform LBT operation per channel/subband/BWP segment.

The term “LBT subband” or “LBT band” used herein may broadly be called as set of physical radio resources or physical radio resource set within a CCA BW i.e. a BW over which the CCA is applied by the UE to access any physical radio resource within that BW. Examples of physical radio resource are time-frequency radio resource etc.

Examples of time-frequency radio resource are RBs, resource elements etc. The embodiments are not limited to any term. Any other similar term e.g., channel, or BWP segment are inter-changeably applicable without losing the meaning.

In the below embodiments, it is assumed that the resource pool or LBT band has PSFCH resources.

Several embodiments are explained taking FIG. 4 below as example, where it is assumed that minGap_{PSFCH-PSSCH}=2, period_{PSFCH}=2 and maxPSFCHoccasionₛₖᵢₚ=1. The shaded region means there is a PSCCH/PSSCH transmission scheduled/performed/detected in the slot(s).

In the first embodiment, a UE performing MCSt based SL transmission (i.e., SL transmission in multiple consecutive SL slots) may recommend to skip a PSFCH occasion (i.e., the UE will not transmit or receive PSFCH in the PSFCH occasion) within the MCSt transmission period when at least one of the below conditions is met:
1) The MCSt transmission comprises data of a service/traffic type/LCH with critical QoS requirements, for instance:
a. the associated priority (e.g., 5QI, PQI, LCH priority or CAPC) of that service/traffic type/LCH is above a (pre)configured priority threshold
b. the associated latency requirement of that service/traffic type/LCH is below a (pre)configured threshold
c. the queuing delay/remained packet delay budget) of data of that service/traffic type/LCH (until the PSFCH occasion) is above/below a (pre)configured threshold
d. the data volume of that service/traffic type/LCH, which is pending for transmission (until the PSFCH occasion) is above a (pre)configured threshold
2) The period since the UE has occupied the channel last time is below a (pre)configured time period. The period of the current MCSt based transmission (until the PSFCH occasion) may or may not be counted.
3) The UE's remaining battery (until the PSFCH occasion) is below a (pre)configured threshold
4) The PSFCH that the UE is expected to receive in the PSFCH occasion is associated to data/LCH with priority below a (pre)configured threshold.
5) The PSFCH that the UE is expected to receive in the PSFCH occasion is associated to data/LCH with latency requirement above a (pre)configured threshold.
6) The PSFCH that the UE needs to transmit in the PSFCH occasion is associated to data/LCH with priority below a (pre)configured threshold.

7) The PSFCH that the UE needs to transmit in the PSFCH occasion is associated to data/LCH with latency requirement above a (pre)configured threshold.

For a UE in mode 1, the gNB may determine whether a PSFCH occasion in the granted resources can be skipped and inform the determination to the UE using DCI, MAC-CE or RRC signaling. The determination may be made based on the reported SL BSR, e.g., a PSFCH occasion may be skipped if, according to the received SL BSR, the LCH priority of the pending SL traffic is above a priority threshold, and/or the queuing delay of the pending SL traffic is above a threshold, and/or the data volume of the pending SL traffic is above a threshold.

For those skipped PSFCH occasions, the UE may fully or partly occupy them for other transmission such as PSSCH transmission thus the gap between transmissions within the MCSt period is no larger than a gap period (e.g., 16 us) below which the UE can skip LBT operation prior to subsequent transmissions.

In the second embodiment, the UE sends signaling to neighbor UEs via one or more of the following signaling alternatives
PC5-S signaling
Discovery message
PC5-RRC signaling
MAC CE
L1 signaling (carried on channels including PSSCH, PSCCH, PSFCH etc)

The signaling comprises at least one of the below information
1) the resource pool(s)/LBT band(s) in which the PSFCH occasion(s) are recommended/allowed to be skipped.
2) The slots in which the UE has determined that the PSFCH occasion(s) will be skipped (i.e., the UE will not transmit or receive PSFCH in those PSFCH occasion(s)).
3) The causes due to which those PSFCH occasion(s) are skipped (e.g., the conditions as described in the first embodiment).

Upon receiving the signaling, a neighbor UE may perform one or more of the below actions:
1) The neighbor UE will skip monitoring PSFCH expected from the UE in PSFCH occasion(s) which are recommended to be skipped by the UE.
2) The neighbor UE will not transmit PSFCH to the UE using PSFCH occasion(s) which are recommended to be skipped by the UE.
3) The neighbor UE postpones its PSFCH reception from the UE or PSFCH transmission to the UE to a later available PSFCH occasion (i.e., not recommended to be skipped by the UE).

In the third embodiment, the UE sends signaling to the gNB via one of the following signaling alternatives
Uu-RRC signaling
MAC CE
L1 signaling (carried on channels including PRACH, PUCCH, PUSCH etc.)

The signaling comprises at least one of the below information:
the resource pool(s) or LBT band(s) in which PSFCH occasion(s) are recommended to be skipped
The slots in which the UE has determined that the PSFCH occasion(s) will be skipped (i.e., the UE will not transmit or receive PSFCH in those PSFCH occasion(s)).
The causes due to which those PSFCH occasion(s) are skipped (e.g., the conditions as described in the first embodiment).

Upon receiving the signaling, the gNB may perform at least one of the below actions:
Forward the signaling to other UEs in the cell via e.g., system information, Uu RRC signaling, MAC CE, or L1 signaling (carried on channels including PDCCH, PDSCH etc.)
Reconfigure PSFCH occasions in the indicated resource pool or LBT band. For instance, less often PSFCH occasions may be configured in time domain to reduce the probability that PSFCH occasions have to be skipped to perform MCSt. Meanwhile, more PSFCH resources in frequency domain may be configured to avoid that the PSFCH resources become insufficient for PSFCH transmission/reception. The gNB may only perform the reconfiguration when having received the signaling from a certain number of UEs and all the signaling indicate that at least a certain number of PSFCH occasions need to be skipped.

In the fourth embodiment, it is (pre)configured a maximum number of consecutive PSFCH occasions (denoted maxPSFCHoccasionₛₖᵢₚ) that can be skipped. maxPSFCHoccasionₛₖᵢₚ may be (pre)configured in different levels, e.g.:
Per Resource Pool.
Per LBT band
Per Tx UE.
Per Rx UE
Per QoS profile, for instance, different latency requirement having different maxPSFCHoccasionₛₖᵢₚ.
Per RB/LCH, for instance, different RB/LCH having different maxPSFCHoccasionₛₖᵢₚ.

The different levels can be applied jointly, e.g., Per resource pool & (Tx) UE, which means a (Tx) UE may be (pre)configured with different maxPSFCHoccasionₛₖᵢₚ in different pools, or Per resource pool & RB/LCH, which means a RB/LCH may be (pre)configured with different maxPSFCHoccasionₛₖᵢₚ in different pools, and so forth.

In another example, multiple maxPSFCHoccasionₛₖᵢₚ corresponding to different levels may be (pre)configured, for instance, one per resource pool maxPSFCHoccasionₛₖᵢₚ and one per Tx UE maxPSFCHoccasionₛₖᵢₚ and one per RB/LCH maxPSFCHoccasionₛₖᵢₚ, etc. The per pool maxPSFCHoccasionₛₖᵢₚ should preferably have the largest value.

In a sub-embodiment, a UE may inform one or more of the above maxPSFCHoccasionₛₖᵢₚ to another UE using e.g., PC5-RRC, SL MAC CE, SCI, etc.

Different maxPSFCHoccasionₛₖᵢₚ may be informed using different signaling, e.g., per pool/LBT band maxPSFCHoccasionₛₖᵢₚ is informed using PC5-RRC or SL MAC CE, per Rx UE maxPSFCHoccasionₛₖᵢₚ is informed in SCI, etc. A UE may obtain per Rx UE maxPSFCHoccasionₛₖᵢₚ from another UE, and, when transmit to that UE, include the per Rx UE maxPSFCHoccasionₛₖᵢₚ of that UE in the SCI.

In another sub-embodiment, (per pool/LBT band) M_{PSFCH-subchannel} is set to M_{PSFCH}/(N_{subchannel-pool/LBT band}*((per pool/LBT band) maxPSFCHoccasionₛₖᵢₚ+1)*period_{PSFCH}), by this it can be guaranteed that there is no conflict in PSFCH transmission (in a resource pool or LBT band) as long as the number of consecutively skipped PSFCH occasions does not exceed maxPSFCHoccasionₛₖᵢₚ (of that resource pool or LBT band).

In the fifth embodiment, for per resource pool or per LBT band maxPSFCHoccasionₛₖᵢₚ, in mode 1, the gNB takes the number of consecutively skipped PSFCH occasions in a resource pool or a LBT band into account when performing SL resource allocation so that the number of consecutively skipped PSFCH occasions in that resource pool or LBT band does not exceed the maxPSFCHoccasionₛₖᵢₚ of that resource pool or LBT band. One way to implement this is that in case consecutively skipped PSFCH occasions in a resource pool or a LBT band equals maxPSFCHoccasionₛₖᵢₚ, the gNB schedules transmission in other resource pool or LBT band(s), or avoids scheduling a transmission leading to that the next PSFCH occasion in the resource pool or LBT band has also to be skipped, for instance, the gNB avoids scheduling a MCSt in the resource pool or LBT band where the slot containing the next PSFCH occasion is a non-last slot of the MCSt. The gNB may indicate in DCI whether MCSt is allowed in the granted resources or whether a PSFCH occasion can be skipped.

Alternatively, the Tx UE takes the number of consecutively skipped PSFCH occasions in a resource pool or a LBT band into account when performing resource (re)selection or when determining how to perform transmission using the obtained resource so that the number of consecutively skipped PSFCH occasions in that resource pool or LBT band does not exceed the maxPSFCHoccasionₛₖᵢₚ of that resource pool or LBT band, where HARQ feedback is expected to be transmitted in those consecutively skipped PSFCH occasions. Taking FIG. 4 as example, the Tx UE detected a SCI in slot n which is transmitted from another UE and which indicates HARQ feedback is enabled, and according to the minGap_{PSFCH-PSSCH}, the HARQ feedback is expected to be transmitted to the other UE in slot n+2. However, in slot n+2, the Tx UE detected another SCI which indicates the HARQ occasion in this slot cannot be used due to e.g., there is a MCSt in slots n+2 and n+3, as according to the maxPSFCHoccasionₛₖᵢₚ only one HARQ occasion can be skipped for the resource pool or LBT band, in mode 2, the Tx UE may select resources in other resource pool or LBT band(s) for its transmission or avoid selecting resources leading to that the next PSFCH occasion in slot n+4 in the resource pool or LBT band has also to be skipped by the other UE, for instance, the Tx UE avoids selecting resources in slots n+4 and n+5 to perform MCSt. In mode 1, the Tx UE selects to not perform MCSt even if it is granted resources in slots n+4 and n+5.

In the sixth embodiment, for per Tx UE maxPSFCHoccasionₛₖᵢₚ, in mode 1, the gNB takes the number of consecutively skipped PSFCH occasions where a specific UE may need to monitor PSFCH (if the PSFCH occasion is not skipped) into account when performing SL resource allocation for that Tx UE so that the number of consecutively skipped PSFCH occasions where the UE may need to monitor PSFCH (if the PSFCH occasion is not skipped) does not exceed the maxPSFCHoccasionₛₖᵢₚ of the UE. Also taking FIG. 4 as example, the gNB has scheduled a UE to perform a SL transmission in slot n, and according to the minGap_{PSFCH-PSSCH}, the UE may expect HARQ feedback in slot n+2 (if HARQ feedback is enabled by the UE). Meanwhile, the gNB has also scheduled the UE to perform a MCSt in slots n+2 and n+3, consequently the UE cannot monitor PSFCH in slot n+2, as according to the maxPSFCHoccasionₛₖᵢₚ only one HARQ occasion can be skipped for the UE, the gNB avoids scheduling the UE to perform a transmission leading to that the UE cannot monitor PSFCH in the next PSFCH occasion (i.e., PSFCH occasion in slot n+4 in the figure), for instance, the gNB avoids scheduling the UE to perform a MCSt in slots n+4 and n+5. The gNB may indicate in DCI sent to the UE whether MCSt is allowed in the granted resources or whether a PSFCH occasion can be skipped.

Alternatively, the Tx UE takes the number of consecutively skipped PSFCH occasions where the Tx UE needs to monitor HARQ feedback in those consecutively skipped PSFCH occasions into account when performing resource (re)selection or when determining how to perform transmission using the obtained resources so that the number of consecutively skipped PSFCH occasions does not exceed the maxPSFCHoccasionₛₖᵢₚ of the Tx UE, where the Tx UE needs to monitor HARQ feedback in those consecutively skipped PSFCH occasions. Also taking FIG. 4 as example, the Tx UE has performed a transmission requiring HARQ feedback in slot n, and according to the minGap_{PSFCH-PSSCH}, the Tx UE can receive the HARQ feedback in slot n+2 if the HARQ occasion is not skipped. However, the Tx UE has performed a MCSt in slots n+2 and n+3 thus cannot monitor HARQ occasion in slot n+2, as according to the maxPSFCHoccasionₛₖᵢₚ only one HARQ occasion can be skipped for the Tx UE, in mode 2, the Tx UE avoids selecting resources leading to that it cannot monitor PSFCH in the next PSFCH occasion in slot n+4, for instance, the Tx UE avoids selecting resources in slots n+4 and n+5 to perform MCSt. In mode 1, the Tx UE selects to not perform MCSt even if it is granted resources in slots n+4 and n+5.

In the seventh embodiment, for per Rx UE maxPSFCHoccasionₛₖᵢₚ, in both mode 1 and mode 2, the Tx UE takes the number of consecutively skipped PSFCH occasions where a Rx UE needs to transmit HARQ feedback in those consecutively skipped PSFCH occasions into account when performing transmissions so that the number of consecutively skipped PSFCH occasions does not exceed the maxPSFCHoccasionₛₖᵢₚ of the Rx UE, where the Rx UE needs to transmit HARQ feedback in those consecutively skipped PSFCH occasions. Also taking FIG. 4 as example, the Tx UE detected a SCI in slot n which is transmitted from another Tx UE and which indicates transmission to an Rx UE and HARQ feedback is enabled, and according to the minGap_{PSFCH-PSSCH}, the Rx UE may send HARQ feedback in slot n+2. However, in slot n+2, the Tx UE detected another SCI which indicates the Rx UE cannot send HARQ feedback in the HARQ occasion in this slot due to e.g., there is a MCSt to the Rx UE in slots n+2 and n+3, as according to the maxPSFCHoccasionₛₖᵢₚ only one HARQ occasion can be skipped for the Rx UE, the Tx UE avoids transmission leading to that the Rx UE cannot send HARQ feedback in the next PSFCH occasion in slot n+4, for instance, in case the Tx UE performs MCSt in slots n+4 and n+5, it excludes the Rx UE in destination selection so that it will not transmit to the Rx UE leading to that the Rx UE has to receive and cannot transmit in the PSFCH occasion.

In the eighth embodiment, for per QOS profile or RB/LCH maxPSFCHoccasionₛₖᵢₚ, the gNB and Tx UE perform similar as in the sixth embodiment with the difference that maxPSFCHoccasionₛₖᵢₚ is (dynamically) determined based on QoS profile of the transmitted traffic or the configured RB/LCH, in case the Tx UE has multiple services with different QoS profiles or multiple RBs/LCHs and correspondingly multiple per QoS profile or RB/LCH maxPSFCHoccasionₛₖᵢₚ, the maxPSFCHoccasionₛₖᵢₚ with the smallest value may be used by the gNB or Tx UE. The gNB or the Tx UE may update the used maxPSFCHoccasionₛₖᵢₚ when a service is started/stopped or a RB/LCH is (re)configured. A gNB may update the used maxPSFCHoccasionₛₖᵢₚ when receiving a new SL BSR from the Tx UE indicating which LCH(s) having available data, a Tx UE may update the used maxPSFCHoccasionₛₖᵢₚ based on RBs/LCHs or QoS profiles of services with available data in Tx buffer and inform the updated maxPSFCHoccasionₛₖᵢₚ to gNB using e.g. MAC CE, alternatively, a Tx UE may update the used maxPSFCHoccasionₛₖᵢₚ for each PSSCH with HARQ feedback enabled depending on the RBs/LCHs or QoS profiles of services transmitted in that PSSCH.

In the ninth embodiment, in case multiple maxPSFCHoccasionₛₖᵢₚ corresponding to different levels are (pre)configured, the gNB/Tx UE may determine how the transmission be scheduled/performed for each maxPSFCHoccasionₛₖᵢₚ according to the above embodiments, and makes a final decision based on all these determinations. For instance, if at least one determination indicates that a UE cannot perform MCSt in certain slots, the MCSt will not be performed.

FIG. 10 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) sandards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub-that is, a hub whose primary function is to route communications to/from the UEs from/to the network node QQ110b. In other embodiments, the hub QQ114 may be a non-dedicated hub-that is, a device which is capable of operating to route communications between the UEs and network node QQ110b, but which is additionally capable of operating as a communication start and/or end point for certain data channels.

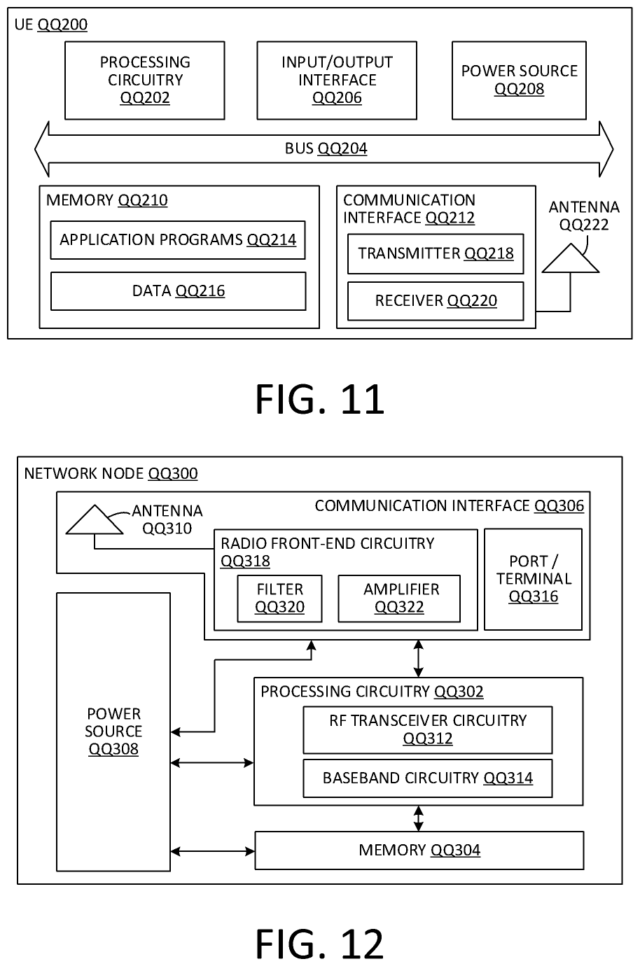

FIG. 11 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 12 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

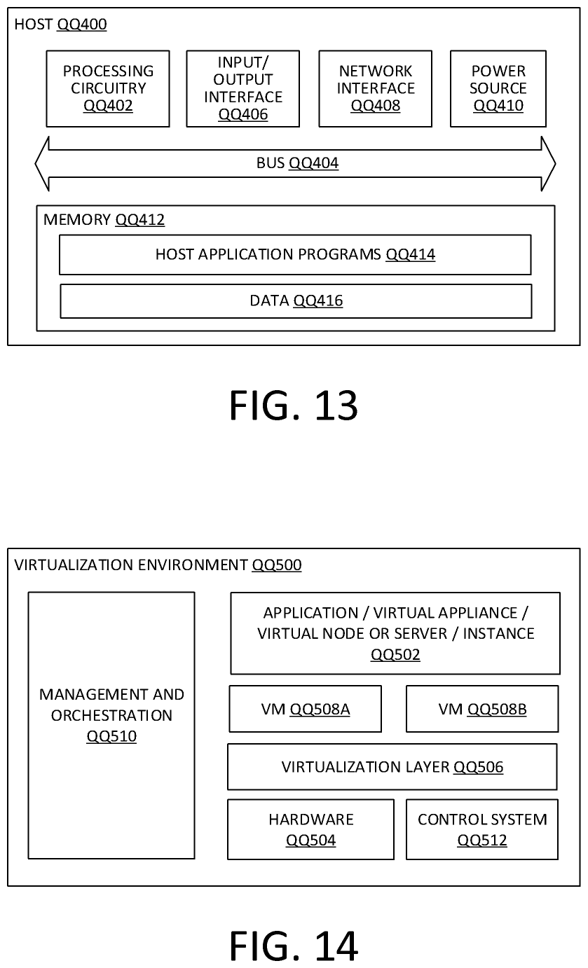

FIG. 13 is a block diagram of a host QQ400, which may be an embodiment of the host QQ116 of FIG. 10, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIG. 11 and FIG. 12, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment QQ500 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

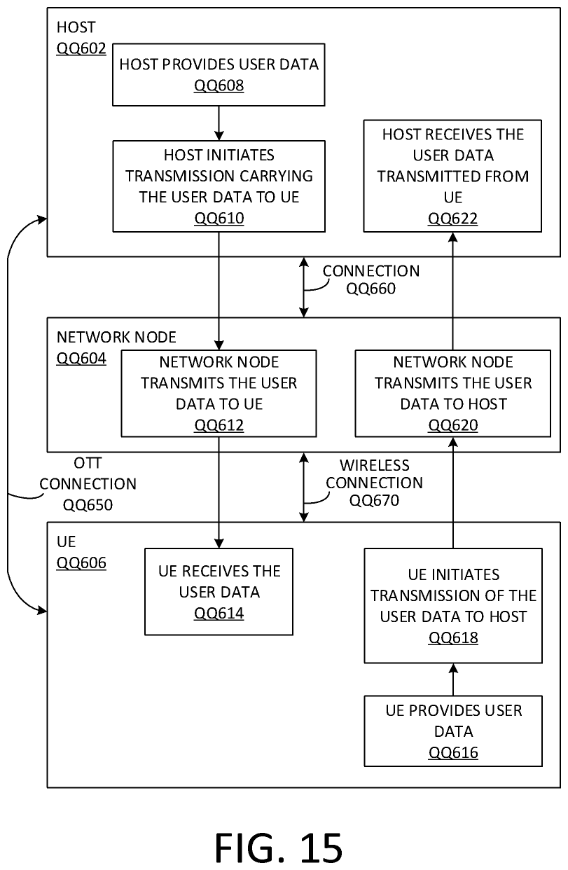

FIG. 15 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 10 and/or UE QQ200 of FIG. 11), network node (such as network node QQ110a of FIG. 10 and/or network node QQ300 of FIG. 12), and host (such as host QQ116 of FIG. 10 and/or host QQ400 of FIG. 13) discussed in the preceding paragraphs will now be described with reference to FIG. 15.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 10) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the data rate, latency, power consumption and thereby provide benefits such as reduced user waiting time, relaxed restriction on file size, improved content resolution, better responsiveness, extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1. A method implemented at a first terminal device, the method comprising:
determining whether or not to skip a Physical Sidelink Feedback Channel (PSFCH) occasion, based on at least one condition or an instruction from a network node; and
one or both of:
in response to determining to skip the PSFCH occasion, transmitting or receiving data in the PSFCH occasion, to or from a second terminal device or the network node; and
in response to determining not to skip the PSFCH occasion, transmitting or receiving Hybrid Automatic Repeat Request (HARQ) feedback in the PSFCH occasion, to or from the second terminal device.

2. The method according to claim 1, wherein the PSFCH occasion is during a Multi-Consecutive Slots transmission (MCSt) period.

3. The method according to claim 1, wherein the at least one condition is associated to one or multiple of:
a Quality of Service (QOS) requirement for data of a service and/or traffic type and/or Logic Channel (LCH) in the MCSt period;
a period for the first terminal device occupying a channel;
remaining battery of the first terminal device;
one or both of a priority of data and LCH associated to a HARQ feedback that the first terminal device expects to receive in the PSFCH occasion;
one or both of a latency requirement of data and LCH associated to a HARQ feedback that the first terminal device expects to receive in the PSFCH occasion;
a priority of data and/or LCH associated to a HARQ feedback that the first terminal device needs to transmit in the PSFCH occasion;
one or both of a latency requirement of data and LCH associated to a HARQ feedback that the first terminal device needs to transmit in the PSFCH occasion;
a maximum number of consecutive PSFCH occasions that are allowed to be skipped (maxPSFCHoccasionₛₖᵢₚ).

4. The method according to claim 1, wherein the at least one condition for determining to skip the PSFCH occasion comprises one or multiple of:
one or both of a priority of data of a service and/or traffic type and LCH in the MCSt period is greater than or equal to a priority threshold;
one or more of a latency requirement of data of a service, a traffic type and LCH in the MCSt period is less than or equal to a latency threshold;
one or more of a queuing delay of data of a service, traffic type and LCH in the MCSt period is greater than or equal to a queuing delay threshold;
one or more of a remaining packet delay budget of data of a service, a traffic type and LCH in the MCSt period is less than or equal to a remaining packet delay budget threshold;
one or more of a data volume of data of a service, a traffic type and LCH in the MCSt period, which is pending for transmission, is greater than or equal to a data volume threshold;
a period since the first terminal device has occupied the channel last time is less than or equal to a period threshold;
remaining battery of the first terminal device is less than or equal to a battery threshold;
one or both of the HARQ feedback that the first terminal device is expecting to receive in the PSFCH occasion is associated to data and LCH with priority less than or equal to a receiving HARQ feedback priority threshold;
one or both of the HARQ feedback that the first terminal device is expecting to receive in the PSFCH occasion is associated to data and LCH with latency requirement greater than or equal to a receiving HARQ feedback latency threshold;
one or both of the HARQ feedback that the first terminal device needs to transmit in the PSFCH occasion is associated to data and LCH with priority less than or equal to a transmitting HARQ feedback priority threshold;
one or both of the HARQ feedback that the first terminal device needs to transmit in the PSFCH occasion is associated to data and LCH with latency requirement greater than or equal to a transmitting HARQ feedback latency threshold;
a number of consecutive PSFCH occasions that has skipped is less than a maximum number of consecutive PSFCH occasions that are allowed to be skipped (maxPSFCHoccasionₛₖᵢₚ).

5. The method according to claim 1, wherein the at least one condition for determining not to skip the PSFCH occasion comprises one or multiple of:
one or more of a priority of data of a service, a traffic type and LCH in the MCSt period is less than or equal to a priority threshold;
one or more of a latency requirement of data of a service, a traffic type and LCH in the MCSt period is greater than or equal to a latency threshold;
one or more of a queuing delay of data of a service, a traffic type and LCH in the MCSt period is less than or equal to a queuing delay threshold;
one or more of a remaining packet delay budget of data of a service, a traffic type and LCH in the MCSt period is greater than or equal to a remaining packet delay budget threshold;
one or more of a data volume of data of a service, a traffic type and LCH in the MCSt period, which is pending for transmission, is less than or equal to a data volume threshold;
a period since the first terminal device has occupied the channel last time is greater than or equal to a period threshold;
remaining battery of the first terminal device is greater than or equal to a battery threshold;
one or both of the HARQ feedback that the first terminal device is expecting to receive in the PSFCH occasion is associated to data and LCH with priority greater than or equal to a receiving HARQ feedback priority threshold;
one or both of the HARQ feedback that the first terminal device is expecting to receive in the PSFCH occasion is associated to data and LCH with latency requirement less than or equal to a receiving HARQ feedback latency threshold;
one or both of the HARQ feedback that the first terminal device needs to transmit in the PSFCH occasion is associated to data and LCH with priority greater than or equal to a transmitting HARQ feedback priority threshold;
one or both of the HARQ feedback that the first terminal device needs to transmit in the PSFCH occasion is associated to and LCH with latency requirement less than or equal to a transmitting HARQ feedback latency threshold;
a number of consecutive PSFCH occasions that has skipped is greater than or equal to a maximum number of consecutive PSFCH occasions that are allowed to be skipped (maxPSFCHoccasionₛₖᵢₚ).

6. The method according to claim 1, further comprising:
receiving a Downlink Control Indicator (DCI), Medium Access Control-Control Element (MAC-CE) or Radio Resource Control (RRC) signaling carrying the instruction from the network node.

7. The method according to claim 1, wherein transmitting or receiving data in the PSFCH occasion comprises performing Physical Sidelink Shared Channel (PSSCH) or Physical Sidelink Control Channel (PSCCH) transmission or reception in full or part of the PSFCH occasion.

8. The method according to claim 1, further comprising:
transmitting first information to a second terminal device via at least one of:
PC5-S signaling;
Discovery message;
PC5-RRC signaling;
sidelink MAC-CE;
Sidelink Control Information (SCI);
Layer 1 (L1) signaling.

9. The method according to claim 1, further comprising:
transmitting second information to the network node via at least one of:
Uu-RRC signaling;
MAC-CE;
Layer 1 (L1) signaling.

10. The method according to claim 8, wherein the first information or second information comprises at least one of:
a resource pool/Listen Before Talk (LBT) band in which the PSFCH occasion is recommended and/or allowed to be skipped;
a slot in which the first terminal device has determined that the PSFCH occasion will be skipped;
the at least one condition for skipping the PSFCH occasion;
the determination that the PSFCH occasion is to be skipped or not to be skipped for the first terminal device;
a recommendation that the PSFCH occasion is to be skipped or not to be skipped for the second terminal device;
the maximum number of consecutive PSFCH occasions that are allowed to be skipped (maxPSFCHoccasionₛₖᵢₚ).

11. The method according to claim 3, wherein the maximum number of consecutive PSFCH occasions that are allowed to be skipped (maxPSFCHoccasionₛₖᵢₚ) is configured per at least one of: resource pool, LBT band, transmitting terminal device, receiving terminal device, QoS profile, Resource Block (RB)/LCH.

12. The method according to claim 11, wherein when the first terminal device is a Tx terminal device, and for per resource pool or per LBT band maxPSFCHoccasionₛₖᵢₚ, further comprising:
taking a number of consecutively skipped PSFCH occasions in a resource pool or a LBT band into account, when performing resource selection/reselection, or when determining how to perform transmission using the obtained resource, so that the number of consecutively skipped PSFCH occasions in that resource pool or LBT band does not exceed the maxPSFCHoccasionₛₖᵢₚ of the resource pool or LBT band.

13. The method according to claim 11, wherein when the first terminal device is a Tx terminal device and for per Tx terminal device maxPSFCHoccasionₛₖᵢₚ, further comprising:
taking a number of consecutively skipped PSFCH occasions where the first terminal device needs to monitor HARQ feedback into account, when performing selection/reselection, or when determining how to perform transmission using the obtained resources, so that the number of consecutively skipped PSFCH occasions does not exceed the maxPSFCHoccasionₛₖᵢₚ of the first terminal device.

14. The method according to claim 11, wherein when the first terminal device is a Tx terminal device and for per Rx terminal device maxPSFCHoccasionₛₖᵢₚ, further comprising:
taking a number of consecutively skipped PSFCH occasions where the Rx terminal device needs to transmit HARQ feedback into account when performing transmissions, so that the number of consecutively skipped PSFCH occasions does not exceed the maxPSFCHoccasionₛₖᵢₚ of the Rx terminal device.

15. The method according to claim 11, wherein when the first terminal device is a Tx terminal device and for per QoS profile or RB/LCH maxPSFCHoccasionₛₖᵢₚ, further comprising:
taking a number of consecutively skipped PSFCH occasions where the first terminal device needs to monitor HARQ feedback into account, when performing selection/reselection, or when determining how to perform transmission using the obtained resources, so that the number of consecutively skipped PSFCH occasions does not exceed the maxPSFCHoccasionₛₖᵢₚ of the first terminal device.

16. The method according to claim 15, wherein the maxPSFCHoccasionₛₖᵢₚ is determined based on QoS profile of the transmitted data or the RB/LCH.

17. The method according to claim 16, wherein the maxPSFCHoccasionₛₖᵢₚ is determined as the maxPSFCHoccasionₛₖᵢₚ with the smallest value among the multiple per QoS profile or RB/LCH maxPSFCHoccasionₛₖᵢₚ.

18. The method according to claim 15, further comprising:
updating the maxPSFCHoccasionₛₖᵢₚ when the service is started/stopped or the RB/LCH is configured/reconfigured.

19. (canceled)

20. (canceled)

21. A method implemented at a second terminal device, the method comprising one or both of:
receiving or transmitting data in a Physical Sidelink Feedback Channel (PSFCH) occasion, from or to a first terminal device, in response to a determination that the PSFCH occasion is to be skipped, wherein the determination is based on at least one condition or an instruction from a network node; and
receiving or transmitting Hybrid Automatic Repeat Request (HARQ) feedback in the PSFCH occasion, from or to a first terminal device, in response to a determination that the PSFCH occasion is not to be skipped, wherein the determination is based on at least one condition or an instruction from a network node.

22-32. (canceled)

33. A method implemented at a network node, the method comprising:
determining an instruction for a first terminal device about whether or not to skip a Physical Sidelink Feedback Channel (PSFCH) occasion, based on at least one condition; and
transmitting the instruction to the first terminal device.

34-60. (canceled)
